(19) United States
(12) Patent Application Publication
(10) Pub. No.: US 2026/0291629 A1
(43) Pub. Date: Sep. 24, 2026

(54) PRECODING WITH CROSS-POLARIZATION IMPAIRMENT

(71) Applicant: InterDigital Patent Holdings, Inc., Wilmington, DE (US)

(72) Inventors: Afshin Haghighat, Ile-Bizard (CA); Mohammad Irfan, Chateauguay (CA); Loic Canonne-Velasquez, Dorval (CA); Jonghyun Park, Syosset, NY (US); Omid Saatlou, Montreal (CA); Moon IL Lee, Melville, NY (US)

(73) Assignee: InterDigital Patent Holdings, Inc., Wilmington, DE (US)

(21) Appl. No.: 19/087,692

(22) Filed: Mar. 24, 2025

(51) Int. Cl. H04B 17/345; H04B 7/06; H04L 5/00

(52) U.S. Cl. CPC H04B 17/345; H04B 7/0626; H04L 5/0048

(57) ABSTRACT

A wireless transmit/receive unit (WTRU) comprises a processor configured to receive configuration information comprising a channel state information (CSI) reference signal (RS) configuration. The processor may receive precoding configuration information, determine a cross-polarization interference value for each subband of a plurality of subbands using CSI-RS resources indicated by the CSI-RS configuration, determine a first subset of the plurality of subbands based on a respective cross-polarization interference value of the subband being below the cross-polarization interference threshold, determine a second subset of the plurality of subbands based on a respective cross-polarization interference value of the subband being above the cross-polarization interference threshold, determine wideband rank information associated with the first subset of the plurality of subbands, determine a first CSI associated with the first subset of the plurality of subbands, and send a first CSI report.

### BACKGROUND

Antenna systems based on cross-polarization may be widely used in multi-antenna transmission systems. Cross-polarized architectures may support implementation of multi-antenna system in a limited form factor. Further, employment of cross-polarized antennas provides some additional diversity. In a cellular system, cross-polarized antennas may be used at both base station (e.g., gNB) and wireless transmit/receive unit (WTRU) sides.

### SUMMARY

A wireless transmit/receive unit (WTRU) may comprise a processor. The processor may be configured to receive configuration information comprising a channel state information (CSI) reference signal (RS) configuration. The processor may be configured to receive precoding configuration information, wherein the precoding configuration information comprises a first precoding hypothesis, a second precoding hypothesis, and/or a cross-polarization interference threshold. The processor may be configured to determine a cross-polarization interference value for each subband of a plurality of subbands using CSI-RS resources indicated by the CSI-RS configuration. The processor may be configured to determine a first subset of the plurality of subbands based on a respective cross-polarization interference value of the subband being below the cross-polarization interference threshold. The processor may be configured to determine a second subset of the plurality of subbands based on a respective cross-polarization interference value of the subband being above the cross-polarization interference threshold. The processor may be configured to determine wideband rank information associated with the first subset of the plurality of subbands. The processor may be configured to determine a first CSI associated with the first subset of the plurality of subbands using the first precoding hypothesis and/or based on the wideband rank information. The processor may be configured to send a first CSI report comprising the first CSI associated with the first subset of the plurality of subbands.

The processor may be configured to determine subband rank information associated with each subband of the second subset of the plurality of subbands. The processor may be configured to determine a second CSI associated with the second subset of the plurality of subbands using the second precoding hypothesis and/or based on the subband rank information associated with each subband of the second subset of the plurality of subbands. The processor may be configured to send a second CSI report. The second CSI report may include, for example, the second CSI associated with the second subset of the plurality of subbands.

The processor may be configured to determine a third CSI associated with the second subset of the plurality of subbands using the second precoding hypothesis and/or based on the subband rank information associated with the first subset of the plurality of subbands. The processor may be configured to send a third CSI report. The third CSI report may include, for example, the third CSI associated with the second subset of the plurality of subbands using the second precoding hypothesis and/or based on the subband rank information associated with the first subset of the plurality of subbands.

The processor may be configured to determine that a subband precoding computation processing for the second subset of the plurality of subbands is within a range and/or determine that the WTRU may not be in a power saving mode. The processor may be configured to determine the second CSI associated with the second subset of the plurality of subbands and/or the subband rank information associated with each subband of the second subset of the plurality of subbands based on the determination that the subband precoding computation processing may be within the range and/or that the WTRU may not be in a power saving mode.

The processor may be configured to determine that a subband precoding computation processing for the second subset of the plurality of subbands may not be within a range or determine that the WTRU may be in a power saving mode. The processor may be configured to generate the first CSI report using the first CSI associated with the first subset of the plurality of subbands and/or not a second CSI associated with the second subset of the plurality of subbands.

The precoding configuration information may include, for example, subband size information.

The first CSI associated with the first subset of the plurality of subbands may include, for example, one or more of the wideband rank information, information related to the first subset of subbands, and/or precoding information based on the first precoding hypothesis.

The second CSI associated with the second subset of the plurality of subbands may include, for example, one or more of information related to the second subset of subbands, subband rank information, and/or precoding information based on the second precoding hypothesis.

The CSI-RS configuration may be associated with, for example, polarization measurements. The polarization measurements may include, for example, direct channel measurement and/or cross-polarization channel measurement.

The configuration information may include, for example, a CSI report resource configuration. The processor may be configured to send the first CSI report based on the CSI report resource configuration.

The first precoding hypothesis may be associated with, for example, zero cross-polarization interference. The second precoding hypothesis may be associated with, for example, non-zero cross-polarization interference.

The processor may be configured to receive configuration information including, for example, a channel state information (CSI) reference signal (RS) configuration. The processor may be configured to receive precoding configuration information. The precoding configuration information may include, for example, a first precoding hypothesis, a second precoding hypothesis, and/or a cross-polarization interference threshold. The processor may be configured to determine a cross-polarization interference value for each subband of a plurality of subbands using CSI-RS resources indicated by the CSI-RS configuration. The processor may be configured to determine a first subset of the plurality of subbands based on a comparison between a respective cross-polarization interference value of the subband and the cross-polarization interference threshold. The processor may be configured to determine a second subset of the plurality of subbands based on a comparison between a respective cross-polarization interference value of the subband and the cross-polarization interference threshold. The processor may be configured to determine wideband rank information associated with the first subset of the plurality of subbands. The processor may be configured to determine a first CSI associated with the first subset of the plurality of subbands using precoding and/or based on the wideband rank information. The processor may be configured to determine subband rank information associated with each subband of the second subset of the plurality of subbands. The processor may be configured to determine a second CSI associated with the second subset of the plurality of subbands using the second precoding hypothesis and based on the subband rank information associated with each subband of the second subset of the plurality of subbands. The processor may be configured to send a CSI report comprising the first CSI associated with the first subset of the plurality of subbands and/or the second CSI associated with the second subset of the plurality of subbands.

A WTRU may be configured to perform a method that includes one or more of the following steps. The method may include receiving configuration information comprising a channel state information (CSI) reference signal (RS) configuration. The method may include receiving precoding configuration information, wherein the precoding configuration information comprises a first precoding hypothesis, a second precoding hypothesis, and/or a cross-polarization interference threshold. The method may include determining a cross-polarization interference value for each subband of a plurality of subbands using CSI-RS resources indicated by the CSI-RS configuration. The method may include determining a first subset of the plurality of subbands based on a respective cross-polarization interference value of the subband being below the cross-polarization interference threshold. The method may include determining a second subset of the plurality of subbands based on a respective cross-polarization interference value of the subband being above the cross-polarization interference threshold. The method may include determining wideband rank information associated with the first subset of the plurality of subbands. The method may include determining a first CSI associated with the first subset of the plurality of subbands using the first precoding hypothesis and/or based on the wideband rank information. The method may include sending a first CSI report comprising the first CSI associated with the first subset of the plurality of subbands.

The method may include determining subband rank information associated with each subband of the second subset of the plurality of subbands. The method may include determining a second CSI associated with the second subset of the plurality of subbands using the second precoding hypothesis and/or based on the subband rank information associated with each subband of the second subset of the plurality of subbands. The method may include sending a second CSI report, wherein the second CSI report comprises the second CSI associated with the second subset of the plurality of subbands.

The method may include determining a third CSI associated with the second subset of the plurality of subbands using the second precoding hypothesis and/or based on the subband rank information associated with the first subset of the plurality of subbands. The method may include sending a third CSI report, wherein the third CSI report comprises the third CSI associated with the second subset of the plurality of subbands using the second precoding hypothesis and/or based on the subband rank information associated with the first subset of the plurality of subbands.

The method may include determining that a subband precoding computation processing for the second subset of the plurality of subbands may be within a range and/or determining that the WTRU may not be in a power saving mode. The method may include determining the second CSI associated with the second subset of the plurality of subbands and/or the subband rank information associated with each subband of the second subset of the plurality of subbands based on the determination that the subband precoding computation processing may be within the range and/or that the WTRU may not be in a power saving mode.

The method may include determining that a subband precoding computation processing for the second subset of the plurality of subbands is not within a range and/or determining that the WTRU may be in a power saving mode. The method may include generating the first CSI report using the first CSI associated with the first subset of the plurality of subbands and not a second CSI associated with the second subset of the plurality of subbands.

The precoding configuration information may include, for example, subband size information.

The first CSI associated with the first subset of the plurality of subbands may include, for example, one or more of the wideband rank information, information related to the first subset of subbands, and/or precoding information based on the first precoding hypothesis.

The second CSI associated with the second subset of the plurality of subbands may include, for example, one or more of information related to the second subset of subbands, subband rank information, or precoding information based on the second precoding hypothesis.

### BRIEF DESCRIPTION OF THE DRAWINGS

FIG. 1A is a system diagram illustrating an example communications system in which one or more disclosed embodiments may be implemented.

FIG. 1B is a system diagram illustrating an example wireless transmit/receive unit (WTRU) that may be used within the communications system illustrated in FIG. 1A according to an embodiment.

FIG. 1C is a system diagram illustrating an example radio access network (RAN) and an example core network (CN) that may be used within the communications system illustrated in FIG. 1A according to an embodiment.

FIG. 1D is a system diagram illustrating a further example RAN and a further example CN that may be used within the communications system illustrated in FIG. 1A according to an embodiment.

FIG. 2 is a system diagram illustrating an example multi-panel dual-polarized antenna system according to an embodiment.

FIG. 3 is a system diagram illustrating an example precoding hypothesis 1 according to an embodiment.

FIG. 4 is a system diagram illustrating an example precoding hypothesis 2 according to an embodiment.

FIG. 5 is a system diagram illustrating an example precoding hypothesis 3 according to an embodiment.

FIG. 6 is a system diagram illustrating an example precoding hypothesis 4 according to an embodiment.

FIG. 7 is a system diagram illustrating an example of the processing time associated to each CSI-RS resource set with no violation according to an embodiment.

FIG. 8 is a system diagram illustrating an example of the processing time associated to each CSI-RS resource set with violation according to an embodiment.

FIG. 9 is a system diagram illustrating an example Two CSI requests (e.g., CSI request 1 based on precoding hypothesis Type 1 and CSI request 2 based on precoding hypothesis 2) resulting in WTRU's computational capability violation, according to an embodiment.

FIG. 10 is a flowchart illustrating an example procedure for precoding with cross-polarization according to an embodiment.

### DETAILED DESCRIPTION

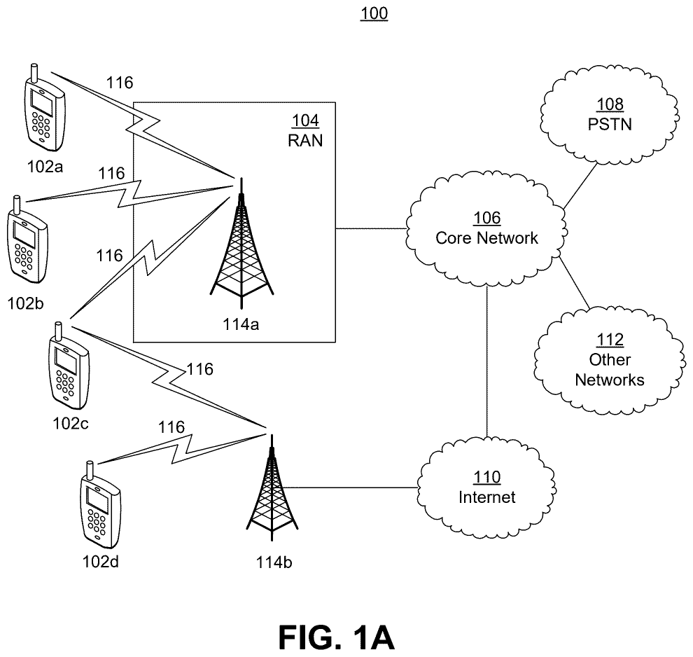

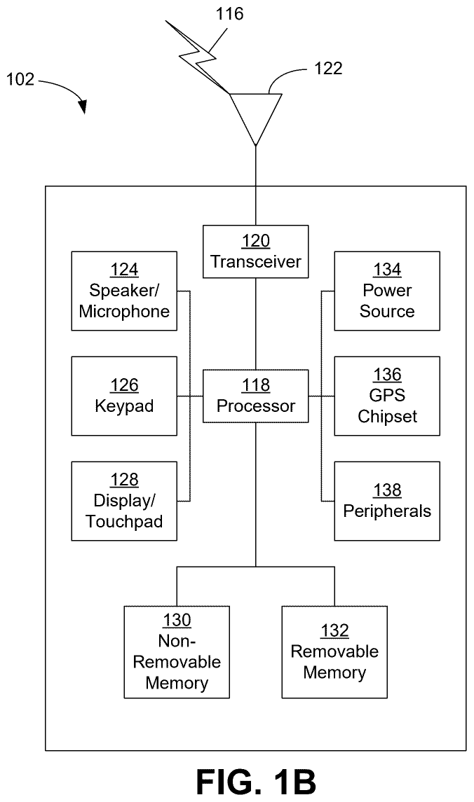

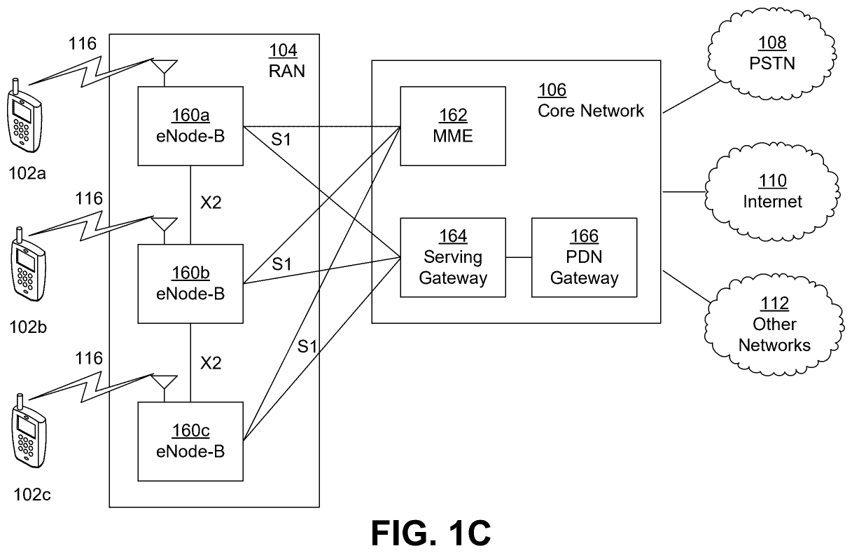

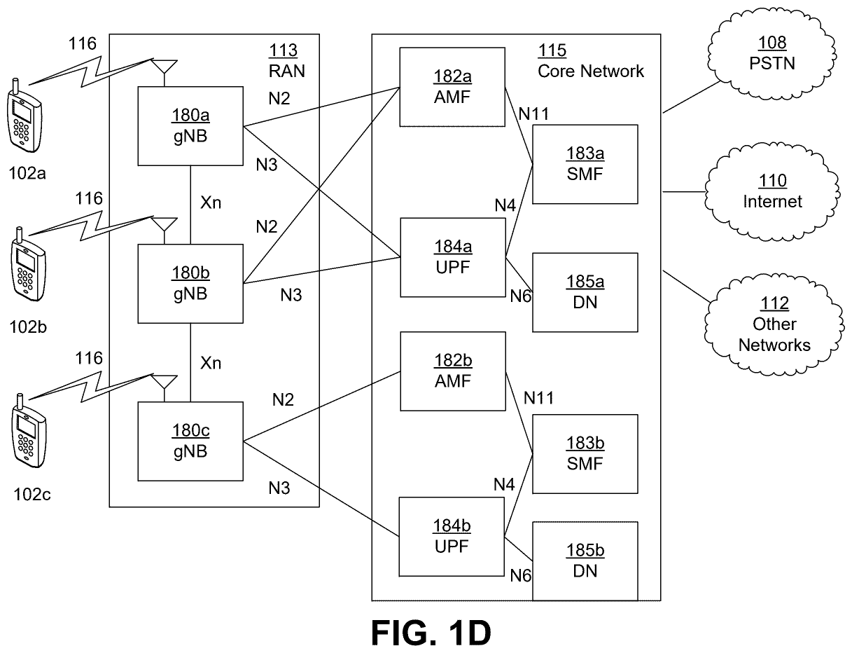

FIG. 1A is a diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word DFT-Spread OFDM (ZT UW DTS-s OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a RAN 104/113, a CN 106/115, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a “station” and/or a “STA”, may be configured to transmit and/or receive wireless signals and may include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a WTRU. Further, any description herein that is described with reference to a UE may be equally applicable to a WTRU (or vice versa). For example, a WTRU may be configured to perform any of the processes or procedures described herein as being performed by a UE (or vice versa).

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106/115, the Internet 110, and/or the other networks 112. By way of example, the base stations 114a, 114b may be a base transceiver station (BTS), a Node-B, an eNode B, a Home Node B, a Home eNode B, a gNB, a NR NodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104/113, which may also include other base stations and/or network elements (not shown), such as a base station controller (BSC), a radio network controller (RNC), relay nodes, etc. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, i.e., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104/113 and the WTRUs 102a, 102b, 102c may implement a radio technology such as Universal Mobile Telecommunications System (UMTS) Terrestrial Radio Access (UTRA), which may establish the air interface 115/116/117 using wideband CDMA (WCDMA). WCDMA may include communication protocols such as High-Speed Packet Access (HSPA) and/or Evolved HSPA (HSPA+). HSPA may include High-Speed Downlink (DL) Packet Access (HSDPA) and/or High-Speed UL Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using New Radio (NR).

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., an eNB and a gNB).

In other embodiments, the base station 114a and the WTRUs 102a, 102b, 102c may implement radio technologies such as IEEE 802.11 (i.e., Wireless Fidelity (WiFi), IEEE 802.16 (i.e., Worldwide Interoperability for Microwave Access (WiMAX)), CDMA2000, CDMA2000 1×, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106/115.

The RAN 104/113 may be in communication with the CN 106/115, which may be any type of network configured to provide voice, data, applications, and/or voice over internet protocol (VoIP) services to one or more of the WTRUs 102a, 102b, 102c, 102d. The data may have varying quality of service (QoS) requirements, such as differing throughput requirements, latency requirements, error tolerance requirements, reliability requirements, data throughput requirements, mobility requirements, and the like. The CN 106/115 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104/113 and/or the CN 106/115 may be in direct or indirect communication with other RANs that employ the same RAT as the RAN 104/113 or a different RAT. For example, in addition to being connected to the RAN 104/113, which may be utilizing a NR radio technology, the CN 106/115 may also be in communication with another RAN (not shown) employing a GSM, UMTS, CDMA 2000, WiMAX, E-UTRA, or WiFi radio technology.

The CN 106/115 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104/113 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors, the sensors may be one or more of a gyroscope, an accelerometer, a hall effect sensor, a magnetometer, an orientation sensor, a proximity sensor, a temperature sensor, a time sensor; a geolocation sensor; an altimeter, a light sensor, a touch sensor, a magnetometer, a barometer, a gesture sensor, a biometric sensor, and/or a humidity sensor.

The WTRU 102 may include a full duplex radio for which transmission and reception of some or all of the signals (e.g., associated with particular subframes for both the UL (e.g., for transmission) and downlink (e.g., for reception) may be concurrent and/or simultaneous. The full duplex radio may include an interference management unit 139 to reduce and or substantially eliminate self-interference via either hardware (e.g., a choke) or signal processing via a processor (e.g., a separate processor (not shown) or via processor 118). In an embodiment, the WRTU 102 may include a half-duplex radio for which transmission and reception of some or all of the signals (e.g., associated with particular subframes for either the UL (e.g., for transmission) or the downlink (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the UL and/or DL, and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (or PGW) 166. While each of the foregoing elements are depicted as part of the CN 106, it will be appreciated that any of these elements may be owned and/or operated by an entity other than the CN operator.

The MME 162 may be connected to each of the eNode-Bs 162a, 162b, 162c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP. The AP may have an access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width via signaling. The primary channel may be the operating channel of the BSS and may be used by the STAs to establish a connection with the AP. In certain representative embodiments, Carrier Sense Multiple Access with Collision Avoidance (CSMA/CA) may be implemented, for example in in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80+80 configuration may be reversed, and the combined data may be sent to the Medium Access Control (MAC).

Sub 1 GHz modes of operation are supported by 802.11af and 802.11ah. The channel operating bandwidths, and carriers, are reduced in 802.11af and 802.11ah relative to those used in 802.11n, and 802.11 ac. 802.11af supports 5 MHz, 10 MHz and 20 MHz bandwidths in the TV White Space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support Meter Type Control/Machine-Type Communications, such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or Network Allocation Vector (NAV) settings may depend on the status of the primary channel. If the primary channel is busy, for example, due to a STA (which supports only a 1 MHz operating mode), transmitting to the AP, the entire available frequency bands may be considered busy even though a majority of the frequency bands remains idle and may be available.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 113 and the CN 115 according to an embodiment. As noted above, the RAN 113 may employ an NR radio technology to communicate with the WTRUs 102a, 102b, 102c over the air interface 116. The RAN 113 may also be in communication with the CN 115.

The RAN 113 may include gNBs 180a, 180b, 180c, though it will be appreciated that the RAN 113 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, gNBs 180a, 108b may utilize beamforming to transmit signals to and/or receive signals from the gNBs 180a, 180b, 180c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (CoMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., containing varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, dual connectivity, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the gNBs 180a, 180b, 180c may communicate with one another over an Xn interface.

The CN 115 shown in FIG. 1D may include at least one AMF 182a, 182b, at least one UPF 184a, 184b, at least one Session Management Function (SMF) 183a, 183b, and possibly a Data Network (DN) 185a, 185b. While each of the foregoing elements are depicted as part of the CN 115, it will be appreciated that any of these elements may be owned and/or operated by an entity other than the CN operator.

The AMF 182a, 182b may be connected to one or more of the gNBs 180a, 180b, 180c in the RAN 113 via an N2 interface and may serve as a control node. For example, the AMF 182a, 182b may be responsible for authenticating users of the WTRUs 102a, 102b, 102c, support for network slicing (e.g., handling of different PDU sessions with different requirements), selecting a particular SMF 183a, 183b, management of the registration area, termination of NAS signaling, mobility management, and the like. Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for machine type communication (MTC) access, and/or the like. The AMF 162 may provide a control plane function for switching between the RAN 113 and other RANs (not shown) that employ other radio technologies, such as LTE, LTE-A, LTE-A Pro, and/or non-3GPP access technologies such as WiFi.

The SMF 183a, 183b may be connected to an AMF 182a, 182b in the CN 115 via an N11 interface. The SMF 183a, 183b may also be connected to a UPF 184a, 184b in the CN 115 via an N4 interface. The SMF 183a, 183b may select and control the UPF 184a, 184b and configure the routing of traffic through the UPF 184a, 184b. The SMF 183a, 183b may perform other functions, such as managing and allocating WTRU IP address, managing PDU sessions, controlling policy enforcement and QoS, providing downlink data notifications, and the like. A PDU session type may be IP-based, non-IP based, Ethernet-based, and the like.

The UPF 184a, 184b may be connected to one or more of the gNBs 180a, 180b, 180c in the RAN 113 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering downlink packets, providing mobility anchoring, and the like.

The CN 115 may facilitate communications with other networks. For example, the CN 115 may include, or may communicate with, an IP gateway (e.g., an IP multimedia subsystem (IMS) server) that serves as an interface between the CN 115 and the PSTN 108. In addition, the CN 115 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local Data Network (DN) 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, Base Station 114a-b, eNode-B 160a-c, MME 162, SGW 164, PGW 166, gNB 180a-c, AMF 182a-ab, UPF 184a-b, SMF 183a-b, DN 185a-b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or may performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

In some examples, procedures and/or functions may include measurement and determination of cross-polarized interference. Procedures and/or functions may include precoding hypothesis and/or channel state information (CSI) structures. Procedures and/or functions may include WTRU procedures for CSI estimation and/or reporting.

In some examples for multiple input multiple output (MIMO) precoding with cross-polarized architecture, the presence and the negative effect of cross-polarization interference may be neglected. Given the shortcoming of the solutions based on such simplification, a realistic channel structure is considered, for example, and disclosed herein, where the cross-polarization interference is not ignored, e.g.,

$$H = [ \begin{matrix}{H}_{VV} & {H}_{HV} \\ {H}_{VH} & {H}_{HH}\end{matrix} ] .$$

To address the cross-polarization interference problem, the following issues for MIMO precoding are discussed. For example, issues for MIMO precoding may include measurement and determination of cross-polarized interference. Issues for MIMO precoding may include precoding hypothesis and/or CSI structures. Issues for MIMO precoding may include WTRU procedures for CSI estimation and/or reporting.

Precoding with cross-polarization impairment may be implemented. For example, a WTRU may report its processing capability (e.g., number of CPUs, processing time per CPU, etc.). A WTRU may receive configuration for CSI measurement and/or reporting that includes at least, CSI-RS configuration for per polarization measurements (e.g., direct and cross-polarization channels) and/or CSI report resource configuration (e.g., physical uplink shared channel (PUSCH)/physical uplink control channel (PUCCH) resources, etc.). In some examples, the WTRU may receive configuration for at least two hypotheses of precoding structure and CSI reporting. For example, the WTRU may receive a first hypothesis based on zero cross-polarization interference. The WTRU may receive a second hypothesis based on non-zero cross-polarization interference. The WTRU may receive a threshold for cross-polarization interference level. The WTRU may receive subband size information.

Based on the configured CSI resources, the WTRU may determine a first and a second subset of subbands based on cross-polarization interference level (e.g., measured interference per subband is below and above a threshold for the first and the second subset of subbands, respectively). Based on the configured CSI resources, the WTRU may determine wideband rank information based on the first subset of subbands and estimates a first CSI using the first precoding hypothesis for the first subset of subbands assuming the determined wideband rank information. The first CSI may include, for instance, the wideband rank information, information related to the first subset of subbands, and/or precoding information based on the first precoding hypothesis.

In some examples, if the required CSI processing for subband precoding computation for the second subset of subbands is within the range supported by the reported WTRU capability, (e.g., number of CPUs, processing time, etc.), and the WTRU is not in a power saving mode, etc., the WTRU may determine rank information for each of subbands in the second subset of subbands within the CSI reporting frequency band. In some examples, if the required CSI processing for subband precoding computation for the second subset of subbands is within the range supported by the reported WTRU capability, (e.g., number of CPUs, processing time, etc.), and the WTRU is not in a power saving mode, etc., the WTRU may estimate a second CSI based on the second precoding hypothesis for the second subset of subbands based on the determined subband rank information. The second CSI may include, for example, information related to the second subset of subbands, subband rank information, and/or precoding information based on the second precoding hypothesis. In some examples, the precoding information based on the second precoding hypothesis may be computed based on the wideband rank associated to the first subset of bands.

In some examples, if the second CSI is estimated and/or available, and the configured CSI reporting resources has sufficient capacity, the WTRU may report the first and second estimated CSIs computed based on the first and second precoding hypothesis, respectively. Otherwise, the WTRU may report only the first estimated CSI computed based on the first precoding hypothesis. In some examples, the WTRU may end CSI reporting after the above procedure is complete.

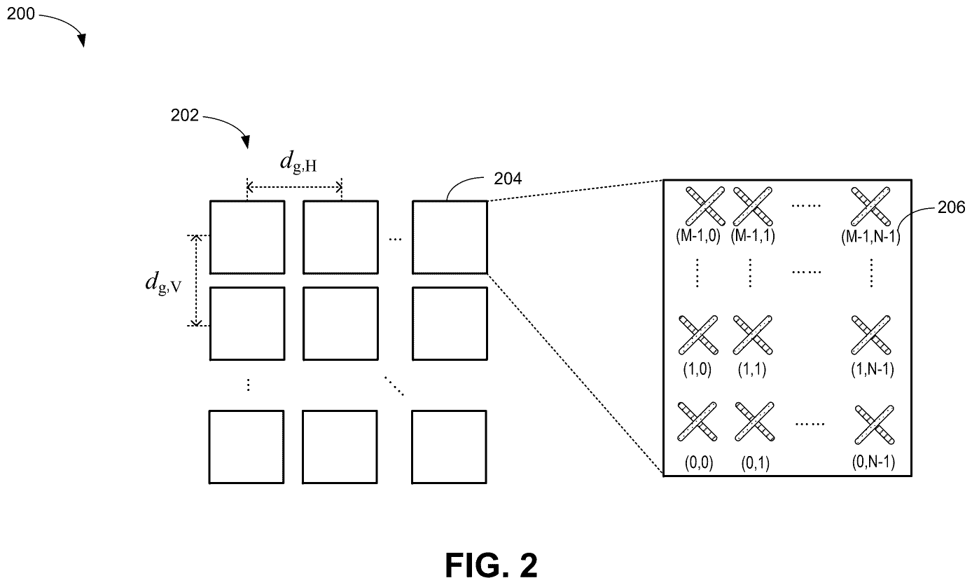

FIG. 2 is a system diagram 200 illustrating an example general architecture of a multi-panel antenna system, where each panel 204 may be based on a cross-polarized implementation. A typical rectangular panel array antenna 202 may be described by the following set of parameters 206. For example, Mg may describe the number of panels in a column. Ng may describe the number of panels in a row. M may describe the number of antenna elements with the same polarization in each column of a panel. N may describe the number of antenna elements with the same polarization in each row of a panel. P may describe the number of polarizations.

In a cross-polarized transmission, the transmission channel may be decomposed in polarization domain. For example, in a system with vertical and horizontal polarizations, a channel may be structured based on four components, HVV, HVH, HHH, HHV, where HVV and HHH may represent the direct, and HVH, HHV may represent indirect and/or interference channels.

$$H = [ \begin{matrix}{H}_{VV} & {H}_{HV} \\ {H}_{VH} & {H}_{HH}\end{matrix} ] .$$

In some examples, in practice, due to implementation impairments and channel behavior, the interference channels, HVH and HHV may not be always negligible. For example, a typical hardware implementation may support a polarization discrimination of less than −20 dB, which can be even more degraded at the WTRU side due to hand-grip effect and proximity to user and other objects. In some examples, while traveling through a channel, the polarization of a wave may rotate following reflections from objects as well as scatterings.

In a multi-antenna system, for example, the overall precoding function for a MIMO system may be expressed as, W=W₁W₂, where W₁ may be the component precoder that represents one or more of initial basis beam selection, wideband, and/or long-term properties of the precoding function, and W₂ may be the component precoder that represents beam selection, subband, short-term, inter-panel co-phasing, and/or inter-polarization co-phase properties of the precoding function.

To simplify the design of the CSI framework, in the current MIMO transmission systems with cross-polarized antennas, cross-polarization interference is assumed zero (e.g., H_{VH}=H_{HV}=0),

$$H = [ \begin{matrix}{H}_{VV} & 0 \\ 0 & {H}_{HH}\end{matrix} ] .$$

In some examples, it may be assumed that H_{VV} and H_{HH} are sufficiently similar, and therefore a same set of basis beams may be used for their corresponding precoding. A simplified structure may also be assumed for W₁,

$${W}_{1} = [ \begin{matrix}B & 0 \\ 0 & B\end{matrix} ] ,$$

where B may represent the preferred set of basis beams for each of polarized transmission. In the above formulation, the following matrix dimensions hold. For example, H: [N_{R}, N_{T}], W₁: [N_{T}, 2N_{B}], W₂: [2N_{B}, N_{L}] and B: [N_{T}/2, N_{B}], where N_{T}, N_{R}, N_{B} and N_{L} are the number of transmissions (TX), receptions (RX), basis beams and layers, respectively.

In some examples described herein, the term “antenna unit” may refer to a physical antenna element and/or a logical antenna port, etc. The term, “first power level” and/or “first power” may refer to the energy per resource element (EPRE) of channel state information reference signals (CSI-RS), the power level of a subset of pilot symbol(s), the power level of the antenna unit(s) transmitting the subset of pilot symbol(s), and/or the EPRE of a CSI-RS resource. The term “second power level” and/or “second power” may refer to the EPRE of a hypothetical downlink (DL) transmission that may be assumed by the WTRU for determination of a CSI report. The terms hypothetical DL transmission power level may be interpreted, considered, treated, assumed, and/or processed by a device (e.g., by a receiver and/or a WTRU) as the DL transmission power level of a device (e.g., a transmitter and/or a base station (e.g., gNB and/or eNB) when it may perform DL transmissions.

In some examples described herein, time instance and/or time-unit may be interchangeably used with slot, symbol, subframe, and/or frame, etc., but still consistent with the methods and/or apparatuses described herein. Frequency instance and/or frequency unit may be interchangeably used with subcarrier, resource element (RE), resource block, subband (SB), band, and/or bandwidth part, but still consistent with the methods and/or apparatuses described herein. SB may be defined as a set of contiguous physical resource blocks (PRBs), and the SB size is the number of PRBs in a SB. A PRB may consist of a set of contiguous subcarriers (e.g., a unit of frequency-domain resource). The term energy may be interchangeably used with the terms power, power of one resource element (EPRE), transmit power, transmitting power, signal to interference and noise ratio (SINR), and/or reference signal received power (RSRP), etc., but still consistent with the methods and/or apparatuses described herein.

Measurement and determination of cross-polarized interference may be implemented. In some examples, polarization-specific reception capabilities may be applied. For example, a WTRU may first report its capability to perform CSI measuring and reporting per polarization type. The WTRU may report its number of receive antennas and the polarization type associated per receive antenna. The WTRU may receive a transmitted signal (e.g., a CSI-RS on co-polarized, or cross-polarized antennas). Each WTRU receive antenna may be associated with a polarization type (e.g., V and/or H). A WTRU may be configured with a CSI reporting setting, and a CSI resource setting (e.g., per bandwidth part (BWP)), where each reporting setting and/or resource setting may be associated to a specific polarization type. A polarization type may consist of, for example, a horizontal and/or vertical (H and/or V) component.

CSI reporting settings per SB and per polarization type may be applied. The CSI reporting setting indicates the codebook configuration to report the cross-polarization precoder components determined, for example, from the structures described below and herein. The codebook configuration may indicate one or more of the following. For example, the codebook configuration may indicate the reporting hypothesis type and quantity. The WTRU may be indicated which codebook type is considered for reporting and/or may determine which precoding indices to report per polarization type as a function of the precoding hypothesis. For instance, the WTRU may be configured with one or more reporting quantities. The reporting quantities may be one or more of layer indicator (LI), rank indicator (RI), precoding matrix indicator (PMI), channel quality indicator (CQI), reference signal received power (RSRP), signal to interference plus noise ratio (SINR), interference, panel co-phasing, etc., per polarization type. The WTRU may measure and/or report a configured report quantity, on a wideband basis and/or per configured subband. A WTRU may perform and/or report measurements per transmitter polarization on a wideband basis, and/or per subband. In some examples, a WTRU may report more than one of a configured report quantity. In some examples, a WTRU may perform a measurement based on a first configured report quantity, on a subband, and if the measurement met a configured threshold, then a WTRU may perform a second measurement and/or report a second type of report quantity. For example, a WTRU may perform interference measurement (e.g., based on a non-zero power (NZP) CSI-RS measurement per polarization per subband), where the NZP CSI-RS may be transmitted on a first polarization. Then, if the measured interference on a second polarization exceeds a configured threshold, a WTRU may perform a rank measurement based on the reception by the first polarization. Therefore, in some examples, a WTRU, conditioned on a first measurement, may measure and/or report multiple report quantities. In some examples, the CSI report may include the information about the subbands where their first measured quantities (e.g., interference) met a configured threshold. For instance, a WTRU may perform CSI measurement over a configured scheduled measurement bandwidth, and report more than one of a configured type of report quantity (e.g., rank) where each reported CSI quantity may be for a different part of the scheduled measurement bandwidth. In some examples, the decision to split the scheduled measurement bandwidth and report more than one configured report quantity, may be based on a measurement. Besides measurement, the split of the band may be based on operational mode, signal strength, interference level, and/or mobility condition, etc. For example, a WTRU may perform a CSI measurement to determine a first configured report quantity per subband, for which, the measured quantity satisfies a configured threshold, and a second group of subbands where the measured quantity does not meet a configured condition. The WTRU may report information about two ranks, where the first RI is for the first group of subbands, and the second RI may be for the remaining subbands.

For example, the codebook configuration may indicate the frequency domain resolution and/or granularity. The frequency domain resolution and/or granularity may include whether the WTRU reports one and/or more parts of the precoder (e.g., W1 or W2) per SB and/or wideband (WB). For instance, the WTRU may be configured via higher layer signaling with a SB size per BWP where a SB may be defined as a set of contiguous physical resource blocks (PRBs), and the SB size may be the number of PRBs in a SB. A PRB may consist of a set of contiguous subcarriers (e.g., a unit of frequency-domain resource). If configured with SB reporting, the WTRU may be indicated with a SB size that is smaller than the number of PRBs in a BWP. If the SB size is equal to the number of PRBs in a BWP, then the reporting may be wideband (WB). For instance, the WTRU may receive different SB size configurations for different polarization type reporting. For example, direct channels H_{VV} and H_{HH} may be configured with a first SB size, and/or indirect channels H_{HV} and H_{VH} may be configured with a second SB size. The WTRU may determine the precoding feedback components with different resolutions for direct and/or indirect channels (e.g., more accuracy for direct channels with precoders per PRB, and/or reduced accuracy for indirect channels with components averaged over multiple PRBs). Determining the precoding feedback components with different resolutions for direct and/or indirect channels may reduce the feedback overhead by allocating more space to report precoding components related to the direct channels, and/or a coarser estimate of indirect components related to the indirect channels. In some examples, a WTRU may perform cross-polarization interference per configured frequency domain resolution. For example, for a configured NZP CSI-RS transmitted on a first type of polarization, a WTRU may perform more than one CSI measurement using more than one receive antenna polarization. For example, a WTRU may be configured with a NZP CSI-RS associated with transmission polarization TX-P1. The WTRU may perform CSI measurement on the transmitted NZP CSI-RS using reception polarization RX-P1 and reception polarization RX-P2. A WTRU may repeat a similar measurement on other polarizations available at the transmitter.

For example, the codebook configuration may indicate the time domain resolution and/or granularity. For example, in periodic CSI (P-CSI), the WTRU may report the CSI according to a preconfigured periodicity. For instance, the WTRU may be configured to report all the precoding components as a function of a single periodicity. Additionally and/or alternatively, each subset of a precoding hypothesis may be associated with a different periodicity. For example, the WTRU may be triggered to report the precoding components associated to a first polarization type (e.g., V) every t1 seconds, and/or a second polarization type (e.g. H) every t2 seconds, and/or joint reporting for both polarization types (e.g., VV and/or HH) every t3 seconds, and/or reporting of cross-polarized type (e.g., VH and/or HV) every t4 seconds. For example, in aperiodic CSI (A-CSI) and/or semi-persistent (SP-CSI) reporting mode, each CSI reporting setting is associated with a CSI index, and the WTRU may receive an A-CSI triggering command (e.g., in a downlink control information (DCI)) to indicate the CSI index to report. If the WTRU supports multiple precoding hypothesis, a single reporting setting may be configured with multiple precoding hypothesis, and the A-CSI triggering command may indicate which hypothesis to trigger. The trigger may indicate a subset of a precoding hypothesis to compute as a function of the polarization associated to the CSI components. For example, the WTRU may be triggered to report the precoding components associated to a first polarization type (e.g., V), or a second polarization type (e.g. H), or joint reporting for both polarization types (e.g., VV and/or HH), or reporting of cross-polarized types (e.g., VH and/or HV).

In some examples, the CSI reporting setting may be associated with an uplink resource where the WTRU may report the CSI feedback. For P-CSI reporting, the WTRU may be configured with a periodic PUCCH resource. For SP/A-CSI reporting, the triggering command (e.g., DCI) may dynamically indicate either a PUCCH resource for reporting CSI, and/or may indicate a grant for a PUSCH resource where the WTRU may multiplex the CSI report.

CSI resource setting per SB and per polarization type may be applied. The CSI resource setting may indicate the reference signals (RSs) and the associated polarization types that the WTRU uses to measure the channel, and each CSI reporting setting may be associated with one or more CSI resource settings as a function of the polarization types configured for precoding type reporting. In some examples, each polarization type is associated with one RS. For example, the WTRU may be configured with one RS for measuring the V polarization, and a second RS for measuring the H polarization. To determine cross-polarization components (e.g., HV and/or VH), the WTUR may be configured with an explicit link between RSs of different polarization types. In some examples, two RSs of different polarization types may be implicitly linked. For example, each RS may be associated with a different transmission and/or reception point TRP (e.g., control resource set pool index (coresetPoollndex), channel measurement resource (CMR) group, transmission configuration indicator (TCI) state) where a first TRP may use a first polarization type, and a second TRP may use a second polarization type. The WTRU may determine that RSs from different TRPs are linked for the purpose of cross-polarization channel measurement. The CSI reporting setting may be configured with the first and/or second RS and the WTRU may determine the CSI reporting contents per polarization type as a function of the measurements obtained from the RSs, and as a function of the precoding hypothesis as disclosed below and herein. In some examples, the WTRU may be configured with a single RS with multiple ports, and each port may be associated with a polarization type explicitly or implicitly (e.g., ports from different TRPs associated to different polarization types). The ports may be co-located and/or transmitted on different TRPs (e.g., ports 1-4 on TRP1, and ports 5-8 on TRP2). The CSI reporting setting may be configured with one RS, and the WTRU may determine the CSI reporting contents per polarization type as a function of the ports associated per polarization type.

In some examples, in the frequency domain, the resource setting may configure the RSs to be transmitted on the entire set of RBs from the BWP. The WTRU may receive a SB size configuration as well to determine the set of SBs for performing CSI measurements. The WTRU may determine different precoders per SB.

Additionally and/or alternatively, a subset of SBs may be transmitted per slot where each subset is associated to one or more polarization types. The WTRU may receive a complete set of SBs by aggregating and/or bundling the measurements from multiple slots (e.g., over time). The WTRU may be configured with a pattern of slots and/or SBs associated per slot. If triggered to report a CSI associated to the pattern, the WTRU may determine the CSI reporting quantities only if it obtained at least one measurement for each of the SB and polarization types configured in the CSI reporting setting.

In some examples, RSs of different polarization types may be configured with different time and/or frequency resources (e.g., non-overlapping and/or orthogonal) so that the WTRU may determine the channels per polarization type on each receive antenna. For example, the WTRU may perform CSI measurements on the configured CSI resources for each polarization to estimate the channels H_{VV}, H_{HV}, H_{VH} and H_{HH}. For example, a WTRU may receive on its V-polarized antenna the V-polarized RS to estimate H_{VV}, and the H-polarized RS to estimate H_{HV}. Then, after the WTRU measures the channels and reports the estimated precoders, the network may precode its transmission per polarization type, and the received signal (e.g., without additive noise) may be expressed as,

$$r = HWx = [ \begin{matrix}{H}_{VV} & {H}_{HV} \\ {H}_{VH} & {H}_{HH}\end{matrix} ] [ \begin{matrix}{W}_{V} \\ {W}_{H}\end{matrix} ] x ,$$

$$\{ \begin{matrix}{r}_{V} = ( {H}_{VV} {W}_{V} + {H}_{HV} {W}_{H} ) x \\ {r}_{H} = ( {H}_{VH} {W}_{V} + {H}_{HH} {W}_{H} ) x\end{matrix}$$

where rⱼ may be the signal received on the antennas with polarization type j, Hᵢⱼ may be the channel coupling the received antennas with polarization type j and the transmitter antennas with polarization type i, and Wᵢ is the precoder over the antennas with polarization type I, and x is the transmitted signal vector over both polarization types.

Precoding hypothesis and CSI structure may be implemented. An exemplary generalized precoder structure in matrix form may be represented in matrix form as

$$W = {W}_{1} {W}_{2} ( {W}_{f} ⊗ {W}_{d} ) \qquad ( 1 )$$

Where ⊗ is the Mathematical Kronecker product operation and the component precoders are given as follows. For example, W₁ may be a component precoder that may include details related to the long-term channel statistics of the wireless channel (e.g., the wideband channel statistics and/or the spatial domain basis functions for the wideband). W₂ may be a component precoder that may include details related to the short-term channel statistics of the wireless channel (e.g., W₂ may include co-phasing information to co-phase the antenna units, co-phase panels, combining coefficients and/or amplitude coefficients, subband precoder information, etc.). W_{f} may be a component precoder that may include details related to compression of the determined CSI (e.g., frequency-domain compression of the determined combining coefficients or amplitude coefficients). W_{d} may be a component precoder that may include details related to compression of the determined CSI (e.g., temporal-domain and/or Doppler-domain compression of the determined combining coefficients and/or amplitude coefficients).

Based on the generalized precoder structure denoted in matrix form above and herein, and based on the absence or presence of the sub-matrices detailed above and herein, the precoders supported in the existing specifications may be summarized as follows. For example, in Rel-15 Type-I and Type-II precoders, the sub-matrices and/or component precoders W_{f} and W_{d} may be absent. In Rel-16 Type-II precoder, the sub-matrix W_{d} may be absent. In Rel-18 Type-II predicted CSI and/or high Doppler precoder, all the sub-matrices W₁, W₂, W_{f} and W_{d} may be present. In Rel-18 Type-II CJT precoder, for N number of TRPs, the wideband CSI may be detailed in a W₁ sub-matrix and/or the subband CSI for each TRP and/or selected TRPs may be included in W₂ and W_{f}. The sub-matrix W_{d} may be absent in the precoder structure of Rel-18 CJT precoder. In the future releases, the Type-II precoder structure may be extended to support high Doppler CJT (e.g., Type-II predicted CSI/high Doppler precoder for CJT) operations for N number of TRPs, wherein the wideband CSI may be detailed in W₁ sub-matrix and the subband CSI for each TRP or selected TRPs is included in W₂ and W_{f}. A single sub-matrix W_{d} may be present for all the TRPs (e.g., the same Doppler domain basis may be used for all TRPs and/or one sub-matrix for each TRP and/or each of the selected TRPs may be used as Doppler domain basis in the precoder structure).

Hereinafter, examples are proposed and/or disclosed related to the structure and/or design of the component precoders W₁ and W₂. However, the examples disclosed herein may equivalently and/or extendedly be applicable to the design of W_{f} and W_{d}.

The structure of W₁ may be applied. For example, a transmitter (e.g., a base station (e.g., eNB and/or gNB), and/or a WTRU) may have multiple antenna units (e.g., with N number of transmit antennas) divided into one or more groups of antenna units. For example, the transmitter may include N/2 first set of antenna units and N/2 second set of antenna units, where the first set of antenna units may be classified and/or called as a horizontal polarization of the antenna units and the second set of antenna ports may be classified and/or called as the vertical polarization of the antenna units. An example of a multi-panel dual polarized antenna units 204 (e.g., horizontally and vertically polarized antenna units) may be depicted in system diagram 200 of FIG. 2.

The component precoder W₁ may include coefficient values for the antenna units for precoding a signal before transmission. The W₁ matrix may have a number of rows equal to less than the number of antenna units, the number of antenna units in a group of antenna units (e.g., a number of horizontally polarized antenna units), and a number of columns less than and/or equal to the minimum of the number of antenna units at the transmitter and number of antenna units at the receiver. For example,

$${W}_{1} = [ \begin{matrix}B & 0 \\ 0 & B\end{matrix} ]$$

which may include the spatial domain (SD) basis vectors and the dimension B is P×v, where P is the number of horizontally and/or vertically polarized antenna ports and v is the number of layers indicated by the rank indicator (RI). In some examples, a set of SD vectors may be the vectors that represent the direction of a MIMO channel. In some examples, when the number of antenna unit groups is equal to one (e.g., when a panel only has horizontally polarized antennas and/or vertically polarized antennas), the structure of W₁ may be as W₁=B. When the number of antenna unit groups is equal to two, for example, when the panel has dual-polarized antenna units (e.g., horizontally polarized antenna units and/or vertically polarized antenna units), the structure of W₁ may be as

$${W}_{1} = [ \begin{matrix}B & 0 \\ 0 & B\end{matrix} ] .$$

When the number of antenna unit groups is equal to three, for example, when the panel has tri-polarized antenna units (e.g., a first, second and/or third polarized antenna units), the structure of W₁ may be as

$${W}_{1} = [ \begin{matrix}B & 0 & 0 \\ 0 & B & 0 \\ 0 & 0 & B\end{matrix} ] .$$

The SD basis vectors may be designed using a discrete Fourier transform (DFT) basis, wavelet transform basis, discrete Cosine transform (DCT) basis, discrete sine transform (DST) basis, wavelet transform (WT) basis, Legendre transform (LT) basis, and/or Chebyshev transform (CT) basis function, etc.

Precoding hypothesis may be applied. In some examples, different precoding hypothesis may be defined and/or specified. For example, each precoding hypothesis may be based on a different structure of W₁, W₂, W_{f} and/or W_{d} for different channel conditions and/or operations. Additionally and/or alternatively, different precoding hypothesis may be formed based on a same codebook structure, while different sets of configured report quantities may be measured and/or reported based on different hypothesis (e.g., WB vs. SB basis). In another example, different precoding hypothesis may be formed based on a same codebook structure, while different level of CSI details (e.g., with or without co-phasing) are reported per subbands or group of subbands. In some examples, different precoding hypothesis may be configured by the base station (e.g., gNB) and/or may be requested by the WTRU for precoder determination from a codebook of precoders. For example, based on the channel conditions and/or interference between two sets of antenna units (e.g., interference between the horizontally and/or vertically polarized antenna units), the base station (e.g., gNB) may configure (e.g., by DCI, medium access control-control element (MAC-CE) and/or radio resource control (RRC)) a precoding hypothesis. Additionally and/or alternatively, a WTRU may determine (e.g., based on a measurement) whether it should perform and/or report CSI based on one or more hypothesis.

For example, the codebook configuration may include indications that indicate the precoding hypothesis (e.g., hypothesis 1 or hypothesis 2) is to be used for CSI determination. The codebook configuration may be based on a precoding hypothesis (e.g., the configured codebook configuration) that is based on precoding hypothesis 1. In some examples, a single codebook structure may be used, but for a first group of subbands a wideband rank may be reported (e.g., a first hypothesis), while for a second group of subbands a narrowband rank information (e.g., per subbands) may be measured and/or reported (e.g., a second hypothesis). In some examples, a single codebook structure may be used, but for a first group of subbands a panel co-phasing information may be reported (e.g., a first hypothesis), while for a second group of subbands, no panel co-phasing (e.g., a second hypothesis) may be measured and reported. The precoding hypothesis may be semi-statically and/or dynamically (e.g., by RRC, MAC-CE, and/or DCI) configured and/or indicated to the WTRU.

In some examples, a precoding hypothesis may be determined based on one or more of the following. For example, a precoding hypothesis may be determined based on when the WTRU observes and/or determines that the cross-polarization interference is exceeding or has exceeded beyond a fixed threshold and/or beyond a base station (e.g., gNB) configured threshold, the WTRU may select a precoding hypothesis for CSI determination. A precoding hypothesis may be determined based on when the number of subbands with non-zero (e.g., or alternatively with zero) coefficients determined by the WTRU (e.g., as in eType-II codebook) increases beyond a threshold value, the WTRU may switch and/or change the precoding hypothesis for the follow-up and/or for the existing CSI request (e.g., the WTRU changes the precoding hypothesis from hypothesis 1 to hypothesis 2 for the current CSI request). A precoding hypothesis may be determined based on the first power level and/or the second power level values are associated with different precoding hypothesis. For example, the WTRU may use a first precoding hypothesis when the configured first power level and/or the second power level is less than a threshold and a second precoding hypothesis may be used when the configured first power level and/or the second power level are equal to or greater than the threshold. A precoding hypothesis may be determined based on the number of physical antenna units and/or the number of logical antenna units. For example, when the number of antenna units (e.g., physical antenna units at the base station (e.g., gNB), logical antenna units (e.g., antenna ports) at the base station (e.g., gNB), physical antenna units at the WTRU, and/or logical antenna units at the WTRU) are above a threshold, the WTRU may use a first precoding hypothesis, otherwise the WTRU may use a second precoding hypothesis. For example, for 128 CSI-RS antenna ports, a first precoding hypothesis may be used and for 32 CSI-RS antenna ports, a second precoding hypothesis may be used.

SD basis selection criterion may be applied. A performance criterion may be used for selection or determination of an SD basis vector or for determination of a set of SD basis vectors from the codebook of SD basis vectors or from a sub-set of the codebook of SD basis vectors. One or more of the following criteria may be used for selection of the SD basis vectors. For example, SD basis vector(s) may be determined based on maximizing of the electromagnetic energy received at the horizontally (e.g., or alternatively at the vertically) polarized receiving antenna units from the horizontally (e.g., or alternatively from the vertically) polarized transmitting antenna unit. SD basis vector(s) may be determined based on the maximizing of the electromagnetic energy received at the horizontally (e.g., or alternatively at the vertically) polarized receiving antenna units from the vertically (e.g., or alternatively from the horizontally) polarized transmitting antenna unit. SD basis vector(s) may be determined based on maximizing of the channel's capacity between the horizontally (e.g., or alternatively the vertically) polarized receiving antenna units and the horizontally (e.g., or alternatively the vertically) polarized transmitting antenna unit. SD basis vector(s) may be determined based on maximizing of the channel's capacity between the horizontally (e.g., or alternatively the vertically) polarized receiving antenna units and the vertically (e.g., or alternatively the horizontally) polarized transmitting antenna units. SD basis vector(s) may be determined and/or selected based on minimizing the electromagnetic leakage between the horizontally polarized antenna units and the vertically polarized antenna units at the transmitting and/or the receiving end. In some examples, the WTRU may determine and/or select an SD basis vector and/or one or more group of SD basis vectors based on one or more of the above-mentioned performance criterions.

In some examples, precoding hypothesis Type-1 may be applied. In precoding hypothesis Type-1, W₁ may be assumed as

$${W}_{1} = [ \begin{matrix}B & 0 \\ 0 & B\end{matrix} ] ,$$

then,

$${W}_{1} = [ \begin{matrix}B & 0 \\ 0 & B\end{matrix} ] .$$

In Type-1 precoding hypothesis, the structure of the component precoder W₁ and W₂ may be different than the structure of the existing W₁ and W₂ component precoders used in the legacy specifications. For example, when Type-1 precoding hypothesis is configured by the base station (e.g., gNB) and/or selected by the WTRU, the WTRU may select a set of N_{B} SD basis vectors. The selected N_{B} SD basis vectors may be partitioned into a first set of SD basis vectors (e.g., N_{B1}) and a second set of SD basis vectors (e.g., N_{B2}) where N_{B}=N_{B1}+N_{B2}. Therefore, the B matrix may include N_{B} SD basis vectors, where each basis vector may have a length equal to the number of antenna units in a group of antenna units. An example of the structure of the matrix B for a dual-polarized antenna units may be as

$$B = [ \begin{matrix}{a}_{1} & {b}_{1} & {c}_{1} & {x}_{1} & {y}_{1} & {z}_{1} \\ {a}_{2} & {b}_{2} & {c}_{2} & {x}_{2} & {y}_{2} & {z}_{2} \\ {a}_{3} & b & {c}_{3} & {x}_{3} & {y}_{3} & {z}_{3}\end{matrix} ]$$

when the number of dual-polarized antenna units on each dimension of a panel, for example, in system diagram 200 of FIG. 2 is P=3 and the total number of dual-polarized antenna units are 2P=6, the set of N_{B1}, =3 SD basis vectors are denoted by a, b, c and the set of N_{B2} SD basis vectors are denoted by x, y, and z, and where each column of B, for example, [a₁, a₂, a₃] represents weights to be applied to a set of antenna units and where each weight is a combination of a real and/or complex number (e.g., a₁=real(a₁)+imaginary(a₁), where real(a₁) is the real part of a₁ and imaginary(a₁) is the imaginary part of a₁.

In some examples, a WTRU may determine a component precoder W₁ that may include one or more sets of SD basis vectors (e.g., two sets of SD basis vectors each having N_{B1} and N_{B2} number of SD basis vectors). For example, a set of basis vector and the number of sets of basis vectors may be determined for one or more (e.g., a subset or all) subbands. For example, for a first subband, the WTRU may determine a first set of SD basis vectors and a second set of SD basis vectors, where the first set of SD basis vectors may have N1 number of SD basis vectors, and the second set of SD basis vectors may have M1 number of SD basis vectors. The first set of SD basis vectors may be determined based on the criteria of maximining the energy received while the second set of SD basis vectors may be determined based on the criteria of minimizing the leakage between horizontally and/or vertically polarized antenna units. For example, for a second subband, the WTRU may determine a first set of SD basis vectors.

In some examples, the WTRU may select one or more SD basis vectors from a set of SD basis vectors at a given frequency unit and/or time-unit for a given layer or group of layers. For example, in a first subband, the WTRU may determine a first SD basis vector from a first set of SD basis vectors. In a second subband, the WTRU may determine a first SD basis vector from a third set of SD basis vectors. In a third subband, the WTRU may determine a second SD basis vector from a first set of SD basis vectors.

In some examples, the component precoder W₂ may include information related to SD basis vectors selection for a given frequency-unit and/or time-unit, from the set of selected SD basis vectors. For example, two set of SD basis vectors may be selected (e.g., a first set with N_{B1} SD basis vectors and a second set with N_{B2} SD basis vectors). The first and the second set of SD basis vectors may be selected in a wideband manner, for example, the first and the second set of SD basis vectors are applicable for all or a sub-set of frequency-units (e.g., for all subbands). For each subband, the component precoder W₂ may include a first indication to indicate the first and/or the second set of SD basis vectors (e.g., a single bit indicator to indicate that the first set of SD basis vectors may be used for selection of the SD basis vector and a second indicator to indicate which of the SD basis vector in the first set of SD basis vector may be selected by the WTRU for a given frequency-unit and/or time-unit).

Precoding based on precoding hypothesis Type-1 in matrix form may be expressed as follows:

$$HW = {HW}_{1} {W}_{2} = [ \begin{matrix}{HH}_{VV} B & {H}_{HV} B \\ {H}_{VH} B & {H}_{HH} B\end{matrix} ] {W}_{2} .$$

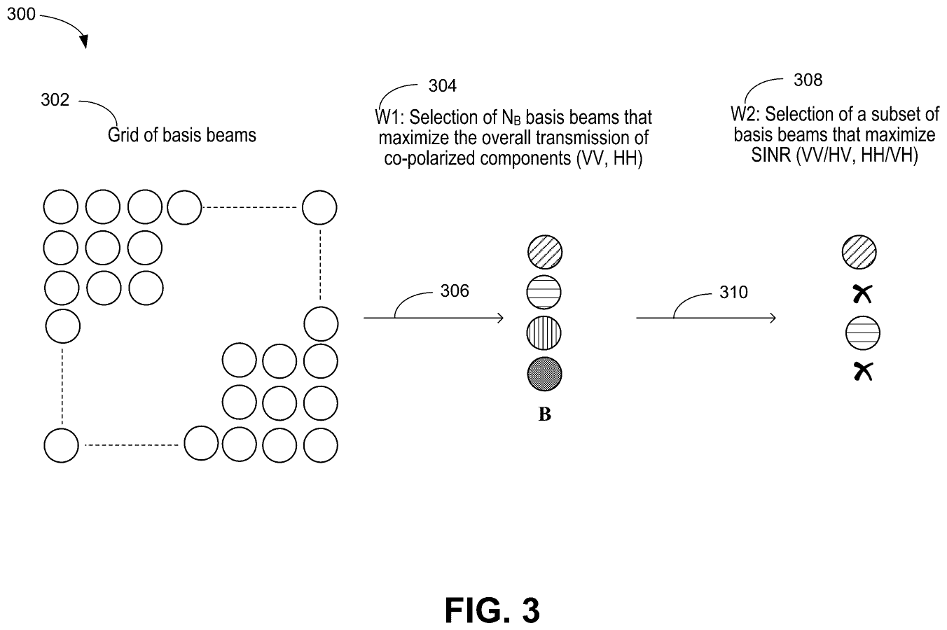

FIG. 3 is a system diagram 300 illustrating an example of the SD basis vectors selection from a gird of SD basis vectors 302. At 304, as part of the component precoder W₁, the WTRU may select four SD basis vectors 306, each selected based on a specific criterion (e.g., by maximizing the energy received at a first and/or second polarization of the receiving end from the first and/or second polarization of the transmitting end), and/or by minimizing the energy leakage between the first polarization and the second polarization at the transmitter and/or receiver. At 308, as part of the component precoder W₂, the WTRU selects one out of the set of four SD basis vectors 310 at a given frequency-unit and/or time-unit.

In some examples, precoding hypothesis Type-2 may be applied. In precoding hypothesis Type-2, W₁ may be assumed as

$${W}_{1} = [ \begin{matrix}{B}_{V} & 0 \\ 0 & {B}_{H}\end{matrix} ] ,$$

then

$$HW = {HW}_{1} {W}_{2} = [ \begin{matrix}{H}_{VV} {B}_{V} & {H}_{HV} {B}_{H} \\ {H}_{VH} {B}_{V} & {H}_{HH} {B}_{H}\end{matrix} ] [ \begin{matrix}{W}_{21} \\ {W}_{22}\end{matrix} ] .$$

In some examples, in precoding hypothesis Type-2, the WTRU may select a set of SD basis vectors for each group of antenna units, for example, the antenna panel has two groups of antenna units (e.g., the horizontally polarized antenna units and the vertically polarized antenna units). The WTRU may select and/or determine a set of SD basis vector for each polarization. For example, for the vertically polarized antenna units, the WTRU may determine the set of SD basis vectors denoted by B_{V}, and for the horizontally polarized antenna units, the WTRU may determine the set of SD basis vectors denoted by B_{H}. The B_{V} and B_{H} SD basis vectors may be selected based on one or more of the SD basis selection criteria. For example, the SD basis vectors in B_{V} may be selected based on maximizing SINR and/or RSRP between the vertical polarization at the transmitter and/or the vertical polarization at the receiver. For example, the SD basis vectors in B_{H} may be selected based on maximizing the channel capacity between the horizontal polarization at the transmitter and/or the horizontal polarization at the receiver.

In some examples, the WTRU may select and/or determine one or more SD basis vectors out of the set of SD basis vectors as part of the component precoder W₂ for each polarization. For example, at a frequency-unit and/or time-unit, the WTRU may select a first SD basis vector from the set of B_{V} SD basis vectors that maximize a performance criterion (e.g., SINR and/or RSRP). At a frequency-unit and/or time-unit, for a given layer, the WTRU may select a first SD basis vector from the set of B_{V} SD basis vectors that maximize a performance criterion (e.g., SINR and/or RSRP). The

$${W}_{2} = [ \begin{matrix}{W}_{21} \\ {W}_{22}\end{matrix} ]$$

when the antenna panel is based on dual-polarized antenna units and

$${W}_{2} = [ \begin{matrix}{W}_{21} \\ \begin{matrix}{W}_{22} \\ {W}_{23}\end{matrix}\end{matrix} ]$$

when the antenna panel is based on tri-polarized antenna units. For dual-polarized antenna units, W₂₁ in W₂ may select one or more SD basis vectors in the B_{H} set of SD basis vectors for the horizontally polarized antenna units and W₂₂ in W₂ may select one or more SD basis vectors in the B_{V} set of SD basis vectors for the vertically polarized antenna units.

Precoding based on precoding hypothesis Type-2 in matrix form may be expressed as,

$$HW = {HW}_{1} {W}_{2} = [ \begin{matrix}{H}_{VV} {B}_{V} & {H}_{HV} {B}_{H} \\ {H}_{VH} {B}_{V} & {H}_{HH} {B}_{H}\end{matrix} ] [ \begin{matrix}{W}_{21} \\ {W}_{22}\end{matrix} ] = HW = {HW}_{1} {W}_{2} = [ \begin{matrix}{H}_{VV} {B}_{V} & {H}_{HV} {B}_{H} \\ {H}_{VH} {B}_{V} & {H}_{HH} {B}_{H}\end{matrix} ] [ \begin{matrix}{W}_{21} \\ {W}_{22}\end{matrix} ]$$

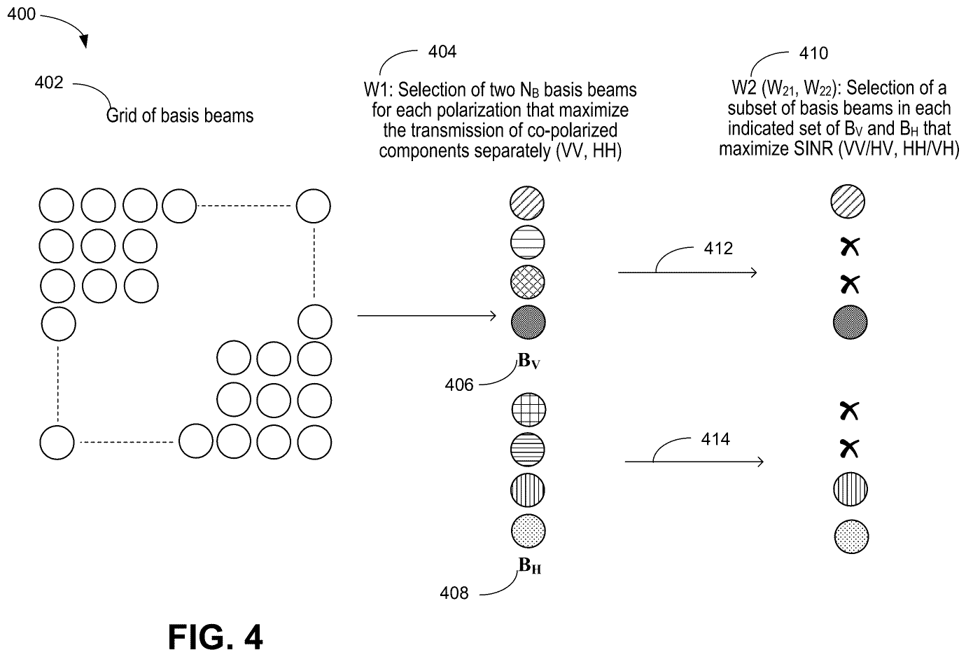

FIG. 4 is a system diagram 400 illustrating an example of the SD basis vectors selection from a grid of SD basis vectors 402, based on precoding hypothesis Type-2. At 404, as part of the component precoder W₁, the WTRU may select four SD basis vectors for the vertically polarized antenna units 406 and four SD basis vectors for the horizontally polarized antenna units 408, where each and/or all SD basis vectors in each and/or all set of SD basis vectors may be selected based on a selection criteria as mentioned above and herein. At 410, as part of the component precoder W₂, the WTRU may select one out of the set of four SD basis vectors at a given frequency-unit and/or time-unit. At 410, as part of the component precoder W₂, the WTRU may make a selection of a subset of basis beams in each indicated set of B_{V} 412 and B_{H} 414 that may maximize SINR.

In some examples, precoding hypothesis Type 3 may be applied. In precoding hypothesis Type 3, W may be assumed as

$${W}_{1} = [ \begin{matrix}B & 0 \\ 0 & B\end{matrix} ] ,$$

then,

$$HW = {HW}_{1} {W}_{2} = [ \begin{matrix}{H}_{VV} B & {H}_{HV} B \\ {H}_{VH} B & {H}_{HH} B\end{matrix} ] [ \begin{matrix}{W}_{21} \\ {W}_{22}\end{matrix} ]$$

In some examples, in precoding hypothesis Type-3, the WTRU may select two sets of SD basis vectors as the component precoder W₁. The first set of N_{B1} basis vectors may be selected based on a first selection criteria and the second set of N_{B2} basis vectors may be selected based on a second selection criteria. For example, the first set of N_{B1} basis vectors may be selected by maximizing the energy transfer between the vertical polarization to vertical polarization and/or the horizontal polarization to horizontal polarization, and the second set of N_{B2} basis vectors may be selected by minimizing the electromagnetic leakage between the vertical and horizontal polarizations. For example, a set of SD basis vectors that achieves the maximum performance (e.g., RSRP, SINR, channel capacity, mutual information, etc.), between the co-polarized antennas (e.g., between the horizontal antenna units to the horizontal antenna units and/or between the vertical antenna units to the vertical antenna units across one or more subbands) may be termed as the first set of SD basis vectors. For example, a set of SD basis vectors that achieves the minimum energy leakage between the cross-polarized antennas (e.g., between the horizontal antenna units and the vertical polarized antenna units across one or more subbands) may be termed as the second set of SD basis vectors.

In some examples, for one or more frequency-units and/or time-units, the WTRU may determine one or more SD basis vectors from one or more sets of SD basis vectors. For example, for a given subband at a given slot, W₂ may include two indications (e.g., a first indication to indicate one or more SD basis vectors that are drawn from a first set of SD basis vectors where the first set of SD basis vectors may be selected based on a first selection criteria, and/or a second indication to indicate one or more SD basis vectors that are drawn from a second set of SD basis vectors where the second set of SD basis vectors may be selected based on a second selection criteria. For example, for each frequency-unit, the WTRU may report one or more sets of SD basis vectors (e.g., a first SD basis vector drawn from a first set of SD basis vectors where the first set of SD basis vectors may be selected according to a first selection criteria, and a second basis vector drawn from a second set of basis vectors where the second set of basis vectors may be selected based on a second selection criteria). The first and/or the second set of basis vectors may be part of the W₁ component precoders and the selection mechanism of the first SD basis vector from the first set of SD basis vector, and the second SD basis vector from the second set of SD basis vector may be part of the W₂ component precoder.

In some examples, based on a plurality of SD basis vectors at a frequency-unit and/or at a time-unit (e.g., based on the two selected SD basis vectors for a subband), the WTRU may determine two different CQIs for the subband (e.g., CQI1 based on the first SD basis vector(s) and CQI2 based on the second SD basis vector(s)). The WTRU may report both CQIs for a subband to the base station (e.g., gNB).

Precoding based on precoding hypothesis Type-3 in matrix form may be expressed as,

$$HW = {HW}_{1} {W}_{2} = [ \begin{matrix}{H}_{VV} B & {H}_{HV} B \\ {H}_{VH} B & {H}_{HH} B\end{matrix} ] [ \begin{matrix}{W}_{21} \\ {W}_{22}\end{matrix} ] = [ \begin{matrix}{H}_{VV} {BW}_{21} + {H}_{HV} {BW}_{22} \\ {H}_{VH} {BW}_{21} + {H}_{HH} {BW}_{22}\end{matrix} ] .$$

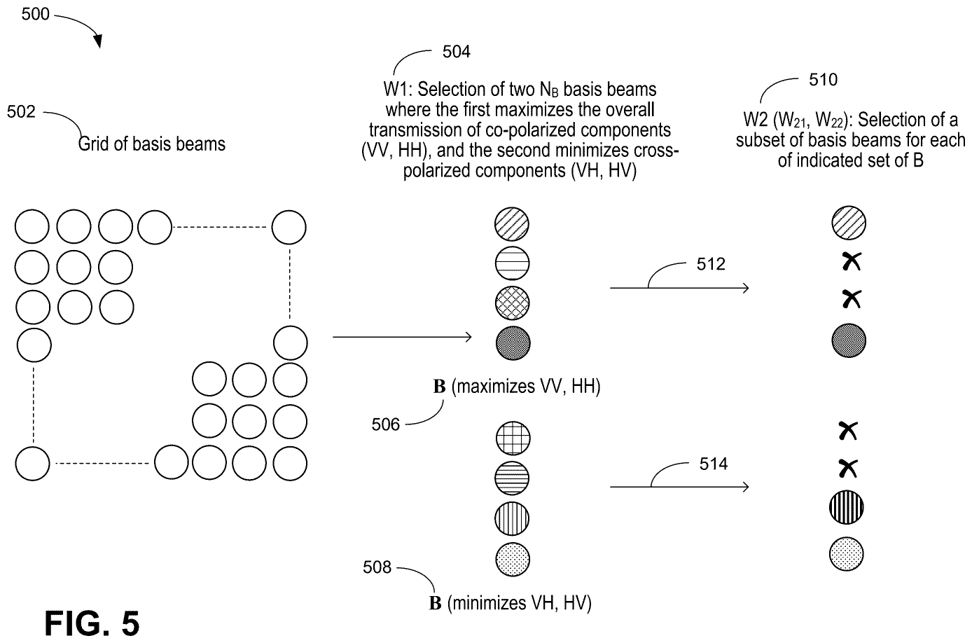

FIG. 5 is a system diagram 500 illustrating an example of the SD basis vectors selection from a grid of SD basis vectors 502, based on precoding hypothesis Type-3. At 504, as part of the component precoder W₁, the WTRU may select two sets of SD basis vectors, where the first set 506 may be determined based on a first criteria and the second set 508 may be determined based on a second criteria. From each set, at 510, as part of the W₂ component precoder, the WTRU may select one or more SD basis vectors for one or more frequency units and/or time-units and report them to the base station (e.g., gNB). From each set, at 510, as part of the W₂ component precoder, the WTRU may make a selection of a subset of basis beams for each of indicated set of B (e.g., set 512, set 514).

In some examples, precoding hypothesis Type-4 may be applied. In precoding hypothesis Type-4, W₁ is assumed as

$${W}_{1} = [ \begin{matrix}{B}_{V} & 0 \\ 0 & {B}_{H}\end{matrix} ] ,$$

then,

$$HW = {HW}_{1} {W}_{2} = [ \begin{matrix}{H}_{VV} {B}_{V} & {H}_{HV} {B}_{H} \\ {H}_{VH} {B}_{V} & {H}_{HH} {B}_{H}\end{matrix} ] [ \begin{matrix}{W}_{21} \\ {W}_{22}\end{matrix} ] .$$

In some examples, in precoding hypothesis Type-4, the WTRU may select one or more sets of SD basis vectors for each group of antenna units, where each group of SD basis vector may be determined and/or selected based on a specific performance criterion. For example, the antenna panel may be based on dual-polarized antenna units (e.g., horizontally polarized antenna units and/or vertically polarized antenna units). For instance, the WTRU may select a first group of SD basis vectors and/or a second group of SD basis vectors for the horizontally polarized antenna units where the first set of SD basis vectors may be selected based on maximizing the energy transfer between the horizontally polarized antenna units at the base station (e.g., gNB) and the WTRU, and the second set of SD basis vectors may be selected based on minimizing the electromagnetic leakage between the cross-polarized antenna units. For instance, the WTRU may select a first group of SD basis vectors and/or a second group of SD basis vectors for the vertically polarized antenna units where the first set of SD basis vectors may be selected based on maximizing the energy transfer between the vertically polarized antenna units at the base station (e.g., gNB) and the vertically polarized antenna units at the WTRU, and the second set of SD basis vectors may be selected based on minimizing the electromagnetic leakage between the cross-polarized antenna units.

In some examples, a part of the W₂ component precoder, for a given frequency-unit and/or time-unit, the WTRU may select at least one SD basis vector from each set of SD basis vectors associated with a group of antenna units. For example, for the horizontally polarized antenna units, the WTRU may select a first SD basis vector from the first set of SD basis vector associated with the horizontally polarized antenna units and/or a first SD basis vector from the second set of SD basis vectors associated with the horizontally polarized antenna units. For the vertically polarized antenna units, the WTRU may select a first SD basis vector from the first set of SD basis vector associated with the vertically polarized antenna units and/or a first SD basis vector from the second set of SD basis vectors associated with the vertically polarized antenna units. For example, for the horizontally polarized antenna units, the WTRU may select at least two SD basis vectors and for vertically polarized antenna units, the WTRU may select at least two SD basis vectors.

In some examples, the WTRU may do one or more of the following. For example, the WTRU may determine two different rank indicator (RI) values based on the selected SD basis vectors in precoding hypothesis Type-3. The WTRU may determine four different RI values based on the selected SD basis vectors in precoding hypothesis Type-4.

In some examples, for a given frequency-unit and/or time-unit, and based on the selected at least four SD basis hypotheses, the WTRU may determine four CQI values. For example, the WTRU may determine a first CQI value, where the first CQI value may be conditioned on the following SD basis vectors. For instance, the first SD basis vector(s) may be selected from the first set of SD basis vectors that are associated with the horizontally polarized antenna units and the first SD basis vector selected from the first set of SD basis vectors that may be associated with the vertically polarized antenna units. For example, the WTRU may determine a second CQI value, where the second CQI value may be conditioned on the following SD basis vectors. For instance, the first SD basis vector selected from the first set of SD basis vectors that may be associated with the horizontally polarized antenna units and the first SD basis vector selected from the second set of SD basis vectors that may be associated with the vertically polarized antenna units. For example, the WTRU may determine a third CQI value, where the third CQI value may be conditioned on the following SD basis vectors. For instance, the first SD basis vector selected from the second set of SD basis vectors that may be associated with the horizontally polarized antenna units and the first SD basis vector selected from the first set of SD basis vectors that may be associated with the vertically polarized antenna units. The WTRU may determine a fourth CQI value, where the fourth CQI value may be conditioned on the following SD basis vectors. For instance, the first SD basis vector selected from the second set of SD basis vectors that may be associated with the horizontally polarized antenna units and the first SD basis vector selected from the second set of SD basis vectors that may be associated with the vertically polarized antenna units.

Table 1 provides an example of PMI/SD basis vectors used for determination of CQIs when dual-polarized antenna units are used.

TABLE 1

| | |
|---|---|
| Horizontally polarized | Vertically polarized |
| antenna units | antenna units |

| | 1^{st} set | 2^{nd} set | 1^{st} set | 2^{nd} set |
|---|---|---|---|---|
| | of SD | of SD | of SD | of SD |
| PMI/CQI | vectors | vectors | vectors | vectors |
| PMI 1/ | √ | | √ | |
| CQI 1 | | | | |
| PMI 2/ | √ | | | √ |
| CQI 2 | | | | |
| PMI 3/ | | √ | √ | |
| CQI 3 | | | | |
| PMI 4/ | | √ | | √ |
| CQI 4 | | | | |

Precoding based-on-precoding hypothesis Type-4 in matrix-form may be expressed as,

$$HW = {HW}_{1} {W}_{2} = [ \begin{matrix}{H}_{VV} {B}_{V} & {H}_{HV} {B}_{H} \\ {H}_{VH} {B}_{V} & {H}_{HH} {B}_{H}\end{matrix} ] [ \begin{matrix}{W}_{21} \\ {W}_{22}\end{matrix} ] = [ \begin{matrix}{H}_{VV} {BW}_{21} + {H}_{HV} {BW}_{22} \\ {H}_{VH} {BW}_{21} + {H}_{HH} {BW}_{22}\end{matrix} ]$$

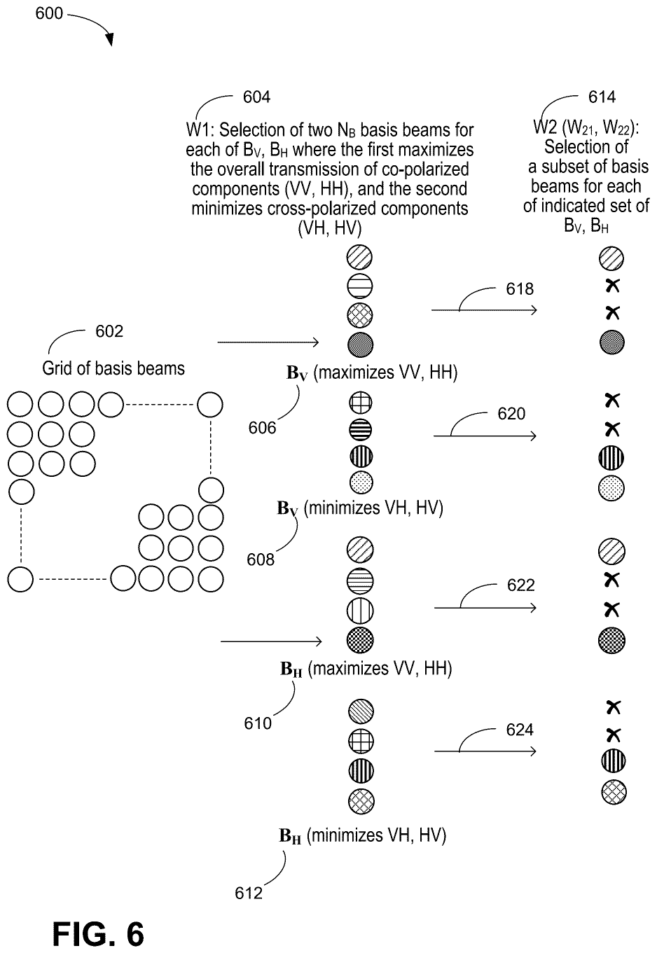

FIG. 6 is a system diagram 600 illustrating an example of the SD basis vectors selection from a grid of SD basis vectors 602, based on precoding hypothesis Type-4. At 604, as part of the component precoder W₁, the WTRU may select two sets of SD basis vectors for each group of antenna units. For example, the WTRU may select a first set 606 and a second set 608 of SD basis vectors for the vertically polarized antenna units and a first set 610 and second set 612 of SD basis vectors for the horizontally polarized antenna units, where the first sets are determined based on a first criteria and the second sets are determined based on a second criteria. From each set, at 614, as part of the W₂ component precoder, the WTRU may select one or more SD basis vectors for one or more frequency units and/or time-units and report them to the base station (e.g., gNB). From each set, at 614, as part of the W₂ component precoder, the WTRU may make a selection of a subset of basis beams for each of indicated set of By (e.g., set 618, set 620) and/or B_{H} (e.g., set 622, set 624). The WTRU may determine different CQI values based on the different SD basis hypothesis (e.g., four CQIs are determined when dual-polarized antenna units are used). The CQIs may be conditioned based on the SD basis vectors as shown in Table 1.

CSI reporting priorities may be applied. Frequency-unit and/or time-unit based priority rules may be defined for reporting the SD basis vectors, the associated CQIs and/or other related CSIs. For example, in precoding hypothesis Type-4, the WTRU may send indicators to indicate four different CQIs and/or four different SD basis vectors for each subband, that may generate a huge overhead. The WTRU may not have sufficient resources to report all the SD basis vectors and/or the CQIs for each subband to the base station (e.g., gNB). Therefore, the WTRU may use a priority rule to prioritize reporting certain CQI values and/or reporting certain SD basis vectors for certain subbands.

In some examples, a priority rule may be defined based on an association between subband indexes and CQI values. For example, for a first subband, CQI 1 may be prioritized over CQI 2, CQI 2 may be prioritized over CQI 3, and CQI 3 may be prioritized over CQI 4. For a second subband, CQI 2 may be prioritized over CQI 1, CQI 3 may be prioritized over CQI 4, and CQI 4 may be prioritized over CQI 1. For a third subband, CQI 3 may be prioritized over CQI 2, CQI 4 may be prioritized over CQI 1, and CQI 1 may be prioritized over CQI 2. For a fourth subband, CQI 4 may be prioritized over CQI 1, CQI 1 may be prioritized over CQI 2, and CQI 2 may be prioritized over CQI 3.

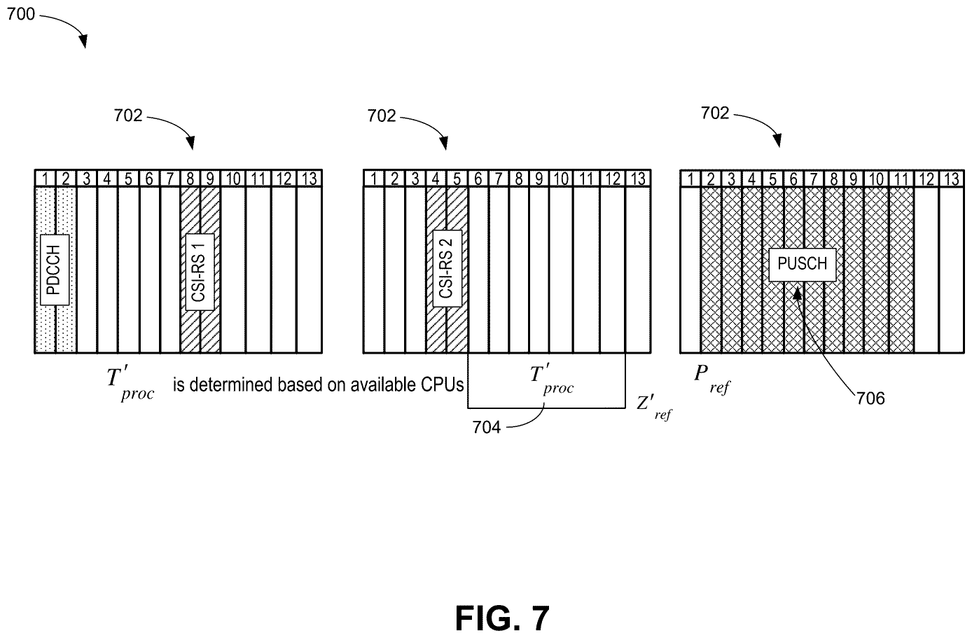

WTRU procedures for CSI estimation and reporting may be implemented. In some examples, a WTRU may send the computational capability in processing CSI requests to a base station (e.g., gNB) for determining the CSI report. For example, the WTRU may report the number of available CPUs including the number of sub-CPUs in each CPU (e.g., the WTRU may report N_{CPU} available CPUs for determining CSI report). Based on this capability to measure the processing time for the CSI report, the WTRU may be configured with a CSI quantity report associated to a CSI-RS resource set (e.g., PMI, CQI, RI and/or the number of subbands). FIG. 7 is a system diagram 700 illustrating an example of the processing time associated to each CSI-RS 702 resource set with no violation. For example, the WTRU may report only N_{CPU}=4 available CPUs and the processing time (e.g., T′_{proc} 704 to report CSI as shown in the system diagram 700 of FIG. 7). The WTRU may be configured with a PUSCH 706 and a CSI report quantity based on the processing time (e.g., T′_{proc} 704 associated to each CSI-RS resource set 702). When N_{CPU} increases, T′_{proc} 704 decreases (e.g., with more available CPUs, less processing time is required for CSI calculations). Thus, the number of N_{CPU} available CPUs indicates T′_{proc} 704.

If the WTRU is configured with a PUSCH 706 after T′_{proc} 704 (e.g., the WTRU owns enough available CPUs to calculate a full CSI on time), the WTRU may be configured with a full CSI report since it is capable to compute a full CSI report with the available CPUs before sending in PUSCH 706. Thus, the WTRU may measure and/or report all H_{VV}, H_{VH}, H_{HV}, H_{HH}, B_{H} and B_{V} for each subband along with W₁₁, W₁₂, W₂₁ and W₂₂. This example may be referred to the “no violation” example throughout this disclosure when the WTRU has enough number of available CPUs to calculate a full CSI including all the cross-polarization impairment precoding so that T′_{proc} 704 is before PUSCH 706, and no violation happens.

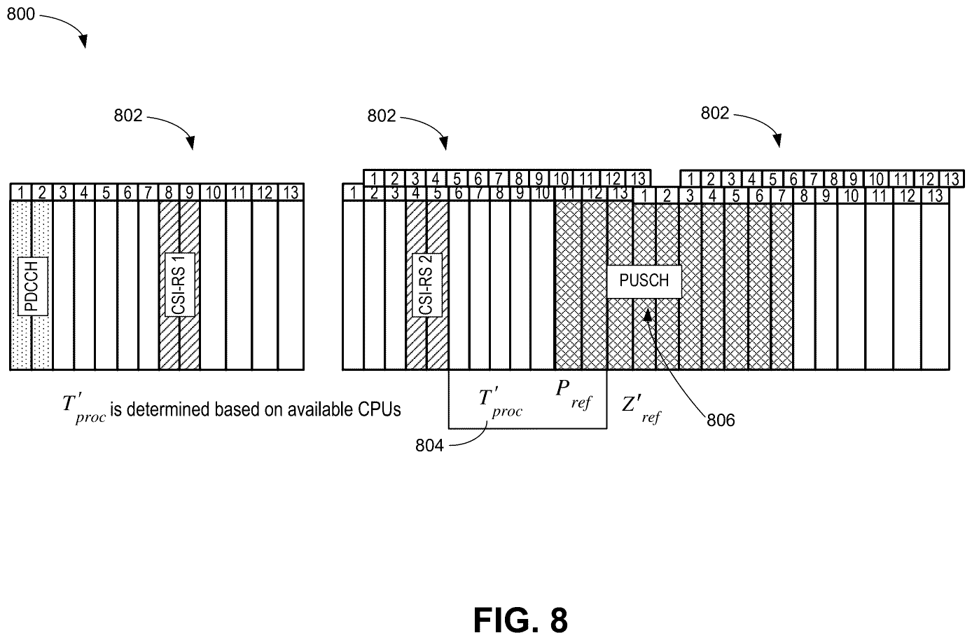

FIG. 8 is a system diagram 800 illustrating an example of the processing time associated to each CSI-RS resource set 802 with violation In some examples, the WTRU may report only N_{CPU}=2 available CPUs and the processing time to report CSI. The WTRU may be configured with a PUSCH 806 and a CSI report quantity. If the WTRU is configured with a PUSCH 806 before T′_{proc} 802 as shown in system diagram 800 of FIG. 8, the WTRU may be configured with a partial CSI report quantities since it is not capable to compute a full CSI report before sending in PUSCH. Thus, a violation happens, and a new rule may be required to be designed. For example, the WTRU may perform one or more of the following. For instance, the WTRU may measure and/or report only H_{VV}, H_{HH}, B_{H} and B_{V} for each subband along with W₁₁, W₁₂, W₂₁ and W₂₂. The WTRU may reduce the number of subbands for reporting and may measure and/or report a full CSI associated to each CSI-RS set. The WTRU may measure and/or report all H_{VV}, H_{VH}, H_{HV}, H_{HH}, B_{H} and B_{V} for each and/or some of subband(s) along with W₁₁ and W₂₂. The WTRU may measure and/or report all H_{VH}, H_{HV}, B_{H} and B_{V} for each and/or some of subband(s) along with W₂₁ and W₂₂. The WTRU may measure and/or report only a full CSI quantity for the wide band.

In some examples, the WTRU may only report the number of available CPUs including the number of sub-CPUs in each CPU (e.g., the WTRU may report N_{CPU} available CPUs N_{SUB-CPU} available sub-CPUs per each CPU for determining CSI report). The base station (e.g., gNB) may calculate the required time that the WTRU may need to calculate a CSI report (e.g., T′_{proc} and schedule a PUSCH along with a CSI quantity for the WTRU). For example, the WTRU may be configured with a PUSCH and a CSI report quantity based on the calculated T′_{proc} associated to each CSI-RS resource set. If the WTRU is configured with a PUSCH with no violation case (e.g., PUSCH is after T′_{proc}), the WTRU may be configured with a full CSI report since it is capable to compute a full CSI report with the available CPUs before sending in PUSCH. Thus, the WTRU may measure and/or report all the cross-polarization impairment precoding (e.g., H_{VV}, H_{VH}, H_{HV}, H_{HH}, B_{H} and B_{V}) for each subband along with W₁₁, W₁₂, W₂₁ and W₂₂.

In some examples, when N_{CPU} and N_{SUB-CPU} decrease, T′_{proc} may increase and the WTRU may enter the violation case (e.g., the WTRU may report only N_{CPU}=2 available CPUs and N_{SUB-CPU}=1 available sub-CPUs to report CSI). The base station (e.g., gNB) may calculate T′_{proc} associated to each CSI-RS resource set and configure a PUSCH with violation case for the WTRU to perform one or more of the following. For instance, the WTRU may measure and/or report only H_{VV}, H_{HH}, B_{H} and B_{V} for some of subbands along with W₁₁, W₁₂, W₂₁ and W₂₂. The WTRU may measure and/or report only H_{VV}, and H_{HH}, for all subbands along with W₁₁, W₁₂, W₂₁ and W₂₂. The WTRU may reduce the number of subbands for reporting and may measure and/or report a full CSI including all the cross-polarization impairment precoding (e.g., H_{VV}, H_{VH}, H_{HV}, H_{HH}, B_{H} and B_{V} for the selected subbands along with W₁₁, W₁₂, W₂₁ and W₂₂ associated to each CSI-RS set. The WTRU may measure and/or report only H_{VH}, H_{H}V, B_{H} and By for each and/or some of subband(s) along with W₁₁ and W₂₂. The WTRU may measure and/or report all H_{VV}, H_{HH}, B_{H} and B_{V} for each and/or some of subband(s) along with W₂₁ and W₂₂.

In some examples, the WTRU may have N_{CPU} available CPUs. The WTRU may report only M_{CPU} available CPUs where M_{CPU}<N_{CPU} for energy saving. The WTRU may be configured with a battery threshold and/or a power saving threshold so that when the WTRU is running less than that power saving threshold, the WTRU may turn off N_{CPU}−M_{CPU} of CPUs and/or report only M_{CPU} available CPUs, and the processing time (e.g., T′_{proc} based on M_{CPU} CPUs). In this example, a WTRU may be configured with a PUSCH and/or a report quantity for cross polarization precoding with or without violation case. For instance, if the WTRU enters into a violation with M_{CPU} CPUs, the WTRU may perform one or more of following. For example, the WTRU may measure and/or report only H_{VV}, H_{HH}, B_{H} and B_{V} for only some of subband(s) along with W₁₁ and W₂₂. The WTRU may measure H_{VV}, H_{VH}, B_{H} and B_{V} for each subband along with W₁₁ and W₁₂. The WTRU may report H_{VV}, H_{HH}=H_{VV}, H_{HV}=H_{VH}, H_{VH}, B_{H} and B_{V} for each subband along with W₁₁,W₁₂, W₂₁=W₁₂ and W₂₂=W₁₁.

In some example, the WTRU may receive configuration for multiple precoding hypothesis types (e.g., the precoding Hypothesis Type-1, Type-2, Type-3, and/or Type-4 as discussed above and herein), and may receive an indication (e.g., via a MAC-CE and/or a DCI) selecting at least two precoding hypothesis types (e.g., out of the multiple types). The indication may be per CSI reporting configuration, for example, indicating that a first CSI reporting configuration may be associated with Type-1 and Type-2, and a second CSI reporting configuration may be associated with Type-3 and Type-4.

For example, on condition that the WTRU receives a CSI reporting trigger (e.g., via a CSI request field in a UL grant) which indicates the first CSI reporting configuration, the WTRU may derive first CSI reporting contents by using Type-1 and Type-2 across configured multiple subbands. The WTRU may determine that a first set of subbands (e.g., of the multiple subbands) satisfy a first condition (e.g., based on configured threshold(s)) that selects the precoding Hypothesis Type-1 based on

$${W}_{1} = [ \begin{matrix}B & 0 \\ 0 & B\end{matrix} ]$$

with the selected set of NB basis beams which maximizes the corresponding performance metric. Based on the determination, the WTRU may generate a first part of CSI contents derived on the first set of subbands based on the precoding hypothesis Type-1. For example, the WTRU may determine that a second set of subbands (e.g., of the multiple subbands) satisfy a second condition (e.g., based on configured threshold(s)) that selects the precoding hypothesis Type-2 based on

$${W}_{1} = [ \begin{matrix}{B}_{V} & 0 \\ 0 & {B}_{H}\end{matrix} ]$$

with the selected two sets of NB basis beams which maximizes the corresponding performance metric. Based on the determination, the WTRU may generate a second part of CSI contents derived on the second set of subbands based on the precoding hypothesis Type-2. For example, the WTRU may report both of the first part of CSI contents and the second part of CSI contents in one reporting instance (e.g., occasion), for instance, based on the concatenation of the first and second parts. In another example, the WTRU may report (e.g., selectively) one of the first part of CSI contents and the second part of CSI contents in one reporting instance (e.g., occasion), based on one or more (e.g., configured) rules to select which part to be reported, for example, where the first part may be selected if at least one subband index (e.g., configured as high-priority) is included in the first set of subbands, if Type-1 is configured as higher-priority than Type-2, and/or if at least one abovementioned criteria for the first part based on available CPUs (or sub-CPUs) is satisfied, etc.

In some examples, on condition that the WTRU receives a CSI reporting trigger (e.g., via a CSI request field in a UL grant) which indicates the second CSI reporting configuration, the WTRU may derive first CSI reporting contents by using Type-3 and Type-4 across configured multiple subbands. For example, the WTRU may determine that a first set of subbands (e.g., of the multiple subbands) satisfy a first condition (e.g., based on configured threshold(s)) that selects the precoding hypothesis Type-3 based on

$${W}_{1} = [ \begin{matrix}B & 0 \\ 0 & B\end{matrix} ]$$

with the selected two set of N_{B} basis beams which maximizes a first corresponding performance metric (e.g., sum energy for co-polarized transmission, such as VV, HH) and minimize a second corresponding performance metric (e.g., sum energy for cross-polarized transmission, such as HV, VH). Based on the determination, the WTRU may generate a first part of CSI contents derived on the first set of subbands based on the precoding hypothesis Type-3. For example, the WTRU may determine that a second set of subbands (e.g., of the multiple subbands) satisfy a second condition (e.g., based on configured threshold(s)) that selects the precoding hypothesis Type-4 based on

$${W}_{1} = [ \begin{matrix}{B}_{V} & 0 \\ 0 & {B}_{H}\end{matrix} ]$$

with the selected two sets of NB basis beams which maximizes a first corresponding performance metric (e.g., sum energy for co-polarized transmission, such as VV, HH) and minimize a second corresponding performance metric (e.g., sum energy for cross-polarized transmission, such as HV, VH). Based on the determination, the WTRU may generate a second part of CSI contents derived on the second set of subbands based on the precoding hypothesis Type-4. The WTRU may report both of the first part of CSI contents and the second part of CSI contents in one reporting instance (e.g., occasion), for example, based on the concatenation of the first and second parts. In another example, the WTRU may report (e.g., selectively) one of the first part of CSI contents and the second part of CSI contents in one reporting instance (e.g., occasion), based on one or more (e.g., configured) rules to select which part to be reported, for example, where the first part is selected if at least one subband index (e.g., configured as “high-priority”) is included in the first set of subbands, if Type-3 is configured as higher-priority than Type-4, and/or if at least one criteria discussed above and herein for the first part based on available CPUs (e.g., or sub-CPUs) is satisfied, etc.

CSI reporting priorities may be applied. Frequency-unit and/or time-unit based priority rules may be defined for reporting the SD basis vectors, the associated CQIs and/or other related CSIs. For example, in precoding hypothesis Type-4, the WTRU may send indicators to indicate four different CQIs and/or four different SD basis vectors for each subband, that may generate a huge overhead. The WTRU may not have sufficient resources to report all the SD basis vectors and/or the CQIs for each subband to the base station (e.g., gNB). Therefore, the WTRU may use a priority rule to prioritize reporting certain CQI values and/or reporting certain SD basis vectors for certain subbands.

In some examples, a priority rule may be defined based on an association between subband indexes and/or CQI values. For example, for a first subband, CQI 1 may be prioritized over CQI 2, CQI 2 may be prioritized over CQI 3, and/or CQI 3 may be prioritized over CQI 4. For a second subband, CQI 2 may be prioritized over CQI 1, CQI 3 may be prioritized over CQI 4, and CQI 4 may be prioritized over CQI 1. For a third subband, CQI 3 may be prioritized over CQI 2, CQI 4 may be prioritized over CQI 1 and CQI 1 may be prioritized over CQI 2. For a fourth subband, CQI 4 may be prioritized over CQI 1, CQI 1 may be prioritized over CQI 2 and CQI 2 may be prioritized over CQI 3.

WTRU processing capability may be applied. A WTRU may declare (e.g., declare to the base station (e.g., gNB) or send to the base station (e.g., gNB)), a processing capability (e.g., a CSI processing capability for one or more of the precoding hypothesis types). For example, the WTRU may declare that it has capabilities to process CSI determination based on a precoding hypothesis Type-I, precoding hypothesis Type-2 and precoding hypothesis Type-3.

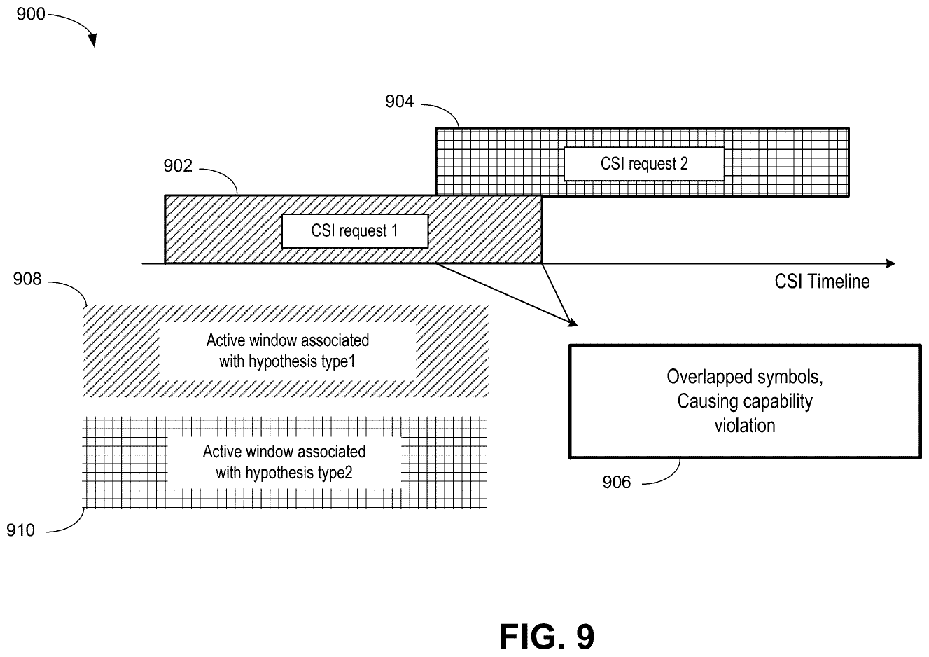

In some examples, a WTRU may be configured to determine a CSI based on one or more precoding hypothesis types (e.g., the WTRU may be configured to determine a CSI based on precoding hypothesis Type 1 and precoding hypothesis Type-2). A WTRU may determine a CSI based on a precoding hypothesis in an active window where the duration of the active window may be different for different precoding hypothesis. An active window may be the time window, starting from the last symbol of the measurement resources to the first symbol of the CSI reporting symbol. The WTRU may utilize a number of computational resources for a given hypothesis type in an active window for determination of a CSI. For example, the WTRU may use N₁ number of computational units in an active window for determination of CSI using precoding hypothesis type-1 and the WTRU may use N₂ number of computational units in an active window for determination of CSI using precoding hypothesis type-2. The WTRU may declare its total computational capability (e.g., the WTRU may declare that it supports N number of CPUs that can be used for CSI determination). Two or more active windows associated with different CSI reports and/or different precoding hypotheses may overlap in at least one or more time symbols. FIG. 9 is a system diagram 900 illustrating an example two CSI requests (e.g., CSI request 1 902 based on precoding hypothesis Type 1 and CSI request 2 904 based on precoding hypothesis 2) resulting in WTRU's computational capability violation 906. For example, the active windows of CSI requests based on precoding hypotheses Type 1 908 and precoding hypothesis type 2 910 may overlap in at least one symbol and N<N₁+N₂, (e.g., the WTRU may not have sufficient computational resource and the WTRU's computational capability may be said to be violated as shown in system diagram 900 of FIG. 9).

In some examples, each precoding hypothesis type may be associated with a priority value (e.g., Type-1 has a higher priority value and Type-2 has a smaller priority value). In the event, when the computational capability violation happens, the WTRU may prioritize a CSI request based on the priority level of the CSI request.

In some examples, a WTRU may receive CSI configuration to support CSI measurement per polarization (e.g., direct and interference channels). The WTRU may receive a trigger for an aperiodic CSI report assuming zero cross-polarization. In some examples, when the WTRU detects cross-polarized interference exceeding a configured threshold, the WTRU may do one of the following. For example, the WTRU may estimate and/or report CSI without consideration of cross-polarization interference. The WTRU may estimate and/or report only some part of the CSI without consideration of cross-polarization interference. The WTRU may replace the remaining estimated CSI (e.g., subband information based on the assumption of zero cross-polarization interference) with some new CSI information related to cross-polarization interference.

In the reported CSI, the WTRU may include an indication to report at least one of the following. For example, the WTRU may include an indication to report the presence of the excessive cross-polarization interference. The WTRU may include an indication to report the measured cross-polarization interference. The WTRU may include an indication to suggest a mode of reporting (e.g., one of CSI feedback structure). The WTRU may include an indication to report a request for an uplink grant to report the full CSI information (e.g., interference level, additional precoding information, etc.)

The WTRU may receive a new CSI configuration (e.g., may also include codebook structure, etc.) and/or CSI reporting request based on the cross-polarization interference.

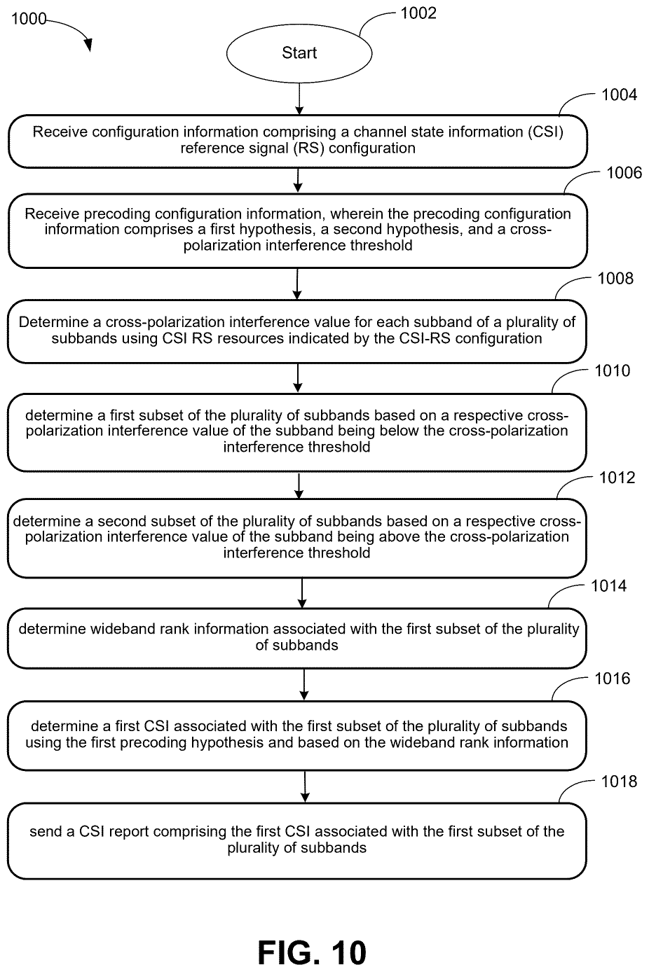

FIG. 10 is an example of a procedure 1000 for precoding with cross-polarization. The procedure 1000 may be performed by a WTRU. The procedure 1000 may start at 1002. At 1004, the WTRU may receive configuration information. The configuration may include a channel state information (CSI) reference signal (RS) configuration. At 1006, the WTRU may receive precoding configuration information. The precoding configuration information may include a first hypothesis, a second hypothesis, and a cross-polarization interference threshold. At 1008, the WTRU may determine a cross-polarization interference value for each subband of a plurality of subbands using CSI RS resources indicated by the CSI-RS configuration. At 1010, the WTRU may determine a first subset of the plurality of subbands based on a respective cross-polarization interference value of the subband being below the cross-polarization interference threshold. At 1012, the WTRU may determine a second subset of the plurality of subbands based on a respective cross-polarization interference value of the subband being above the cross-polarization interference threshold. At 1014, the WTRU may determine wideband rank information associated with the first subset of the plurality of subbands. At 1016, the WTRU may determine a first CSI associated with the first subset of the plurality of subbands using the first precoding hypothesis and based on the wideband rank information. At 1018, the WTRU may send a CSI report comprising the first CSI associated with the first subset of the plurality of subbands.

1. A wireless transmit/receive unit (WTRU) comprising:
a processor configured to:
receive configuration information comprising a channel state information (CSI) reference signal (RS) configuration;
receive precoding configuration information, wherein the precoding configuration information comprises a first precoding hypothesis, a second precoding hypothesis, and a cross-polarization interference threshold;
determine a cross-polarization interference value for each subband of a plurality of subbands using CSI-RS resources indicated by the CSI-RS configuration;
determine a first subset of the plurality of subbands based on a respective cross-polarization interference value of the subband being below the cross-polarization interference threshold;
determine a second subset of the plurality of subbands based on a respective cross-polarization interference value of the subband being above the cross-polarization interference threshold;
determine wideband rank information associated with the first subset of the plurality of subbands;
determine a first CSI associated with the first subset of the plurality of subbands using the first precoding hypothesis and based on the wideband rank information; and
send a first CSI report comprising the first CSI associated with the first subset of the plurality of subbands.

2. The WTRU of claim 1, wherein the processor is configured to:
determine subband rank information associated with each subband of the second subset of the plurality of subbands;
determine a second CSI associated with the second subset of the plurality of subbands using the second precoding hypothesis and based on the subband rank information associated with each subband of the second subset of the plurality of subbands; and
send a second CSI report, wherein the second CSI report comprises the second CSI associated with the second subset of the plurality of subbands.

3. The WTRU of claim 2, wherein the processor is configured to:
determine a third CSI associated with the second subset of the plurality of subbands using the second precoding hypothesis and based on the subband rank information associated with the first subset of the plurality of subbands; and
send a third CSI report, wherein the third CSI report comprises the third CSI associated with the second subset of the plurality of subbands using the second precoding hypothesis and based on the subband rank information associated with the first subset of the plurality of subbands.

4. The WTRU of claim 2, wherein the processor is configured to:
determine that a subband precoding computation processing for the second subset of the plurality of subbands is within a range or determine that the WTRU is not in a power saving mode; and
determine the second CSI associated with the second subset of the plurality of subbands and the subband rank information associated with each subband of the second subset of the plurality of subbands based on the determination that the subband precoding computation processing is within the range or that the WTRU is not in a power saving mode.

5. The WTRU of claim 1, wherein the processor is configured to:
determine that a subband precoding computation processing for the second subset of the plurality of subbands is not within a range or determine that the WTRU is in a power saving mode; and
generate the first CSI report using the first CSI associated with the first subset of the plurality of subbands and not a second CSI associated with the second subset of the plurality of subbands.

6. The WTRU of claim 1, wherein the precoding configuration information comprises subband size information.

7. The WTRU of claim 1, wherein the first CSI associated with the first subset of the plurality of subbands comprises one or more of the wideband rank information, information related to the first subset of subbands, or precoding information based on the first precoding hypothesis.

8. The WTRU of claim 1, wherein the second CSI associated with the second subset of the plurality of subbands comprises one or more of information related to the second subset of subbands, subband rank information, or precoding information based on the second precoding hypothesis.

9. The WTRU of claim 1, wherein the CSI-RS configuration is associated with polarization measurements, and wherein the polarization measurements comprise direct channel measurement and cross-polarization channel measurement.

10. The WTRU of claim 1, wherein the configuration information comprises a CSI report resource configuration, and wherein the processor is configured to send the first CSI report based on the CSI report resource configuration.

11. The WTRU of claim 1, wherein the first precoding hypothesis is associated with zero cross-polarization interference, and wherein the second precoding hypothesis is associated with non-zero cross-polarization interference.

12. A method performed by a wireless transmit/receive unit (WTRU), the method comprising:
receiving configuration information comprising a channel state information (CSI) reference signal (RS) configuration;
receiving precoding configuration information, wherein the precoding configuration information comprises a first precoding hypothesis, a second precoding hypothesis, and a cross-polarization interference threshold;
determining a cross-polarization interference value for each subband of a plurality of subbands using CSI-RS resources indicated by the CSI-RS configuration;
determining a first subset of the plurality of subbands based on a respective cross-polarization interference value of the subband being below the cross-polarization interference threshold;
determining a second subset of the plurality of subbands based on a respective cross-polarization interference value of the subband being above the cross-polarization interference threshold;
determining wideband rank information associated with the first subset of the plurality of subbands;
determining a first CSI associated with the first subset of the plurality of subbands using the first precoding hypothesis and based on the wideband rank information; and
sending a first CSI report comprising the first CSI associated with the first subset of the plurality of subbands.

13. The method of claim 12, wherein the processor is configured to:
determining subband rank information associated with each subband of the second subset of the plurality of subbands;
determining a second CSI associated with the second subset of the plurality of subbands using the second precoding hypothesis and based on the subband rank information associated with each subband of the second subset of the plurality of subbands; and
sending a second CSI report, wherein the second CSI report comprises the second CSI associated with the second subset of the plurality of subbands.

14. The method of claim 13, wherein the processor is configured to:
determining a third CSI associated with the second subset of the plurality of subbands using the second precoding hypothesis and based on the subband rank information associated with the first subset of the plurality of subbands; and
sending a third CSI report, wherein the third CSI report comprises the third CSI associated with the second subset of the plurality of subbands using the second precoding hypothesis and based on the subband rank information associated with the first subset of the plurality of subbands.

15. The method of claim 13, wherein the processor is configured to:
determining that a subband precoding computation processing for the second subset of the plurality of subbands is within a range or determine that the WTRU is not in a power saving mode; and
determining the second CSI associated with the second subset of the plurality of subbands and the subband rank information associated with each subband of the second subset of the plurality of subbands based on the determination that the subband precoding computation processing is within the range or that the WTRU is not in a power saving mode.

16. The method of claim 12, wherein the processor is configured to:
determining that a subband precoding computation processing for the second subset of the plurality of subbands is not within a range or determine that the WTRU is in a power saving mode; and
generating the first CSI report using the first CSI associated with the first subset of the plurality of subbands and not a second CSI associated with the second subset of the plurality of subbands.

17. The method of claim 12, wherein the precoding configuration information comprises subband size information.

18. The method of claim 12, wherein the first CSI associated with the first subset of the plurality of subbands comprises one or more of the wideband rank information, information related to the first subset of subbands, or precoding information based on the first precoding hypothesis.

19. The method of claim 12, wherein the second CSI associated with the second subset of the plurality of subbands comprises one or more of information related to the second subset of subbands, subband rank information, or precoding information based on the second precoding hypothesis.

20. A wireless transmit/receive unit (WTRU) comprising:
a processor configured to:
receive configuration information comprising a channel state information (CSI) reference signal (RS) configuration;
receive precoding configuration information, wherein the precoding configuration information comprises a first precoding hypothesis, a second precoding hypothesis, and a cross-polarization interference threshold;
determine a cross-polarization interference value for each subband of a plurality of subbands using CSI-RS resources indicated by the CSI-RS configuration;
determine a first subset of the plurality of subbands based on a comparison between a respective cross-polarization interference value of the subband and the cross-polarization interference threshold;
determine a second subset of the plurality of subbands based on a comparison between a respective cross-polarization interference value of the subband and the cross-polarization interference threshold;
determine wideband rank information associated with the first subset of the plurality of subbands;
determine a first CSI associated with the first subset of the plurality of subbands using precoding and based on the wideband rank information; and
determine subband rank information associated with each subband of the second subset of the plurality of subbands; and
determine a second CSI associated with the second subset of the plurality of subbands using the second precoding hypothesis and based on the subband rank information associated with each subband of the second subset of the plurality of subbands; and
send a CSI report comprising the first CSI associated with the first subset of the plurality of subbands and the second CSI associated with the second subset of the plurality of subbands.
